(19) United States
(12) Patent Application Publication
(10) Pub. No.: US 2008/0206493 A1
(43) Pub. Date: Aug. 28, 2008

(54) METHOD FOR PRODUCING OPTICAL FILM AND OPTICAL FILM

(75) Inventors: Kazuhiro SHIMODA, Odawara-shi (JP); Tsuyoshi Yamamoto, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/035,806

(22) Filed: Feb. 22, 2008

(30) Foreign Application Priority Data
Feb. 23, 2007 (JP) 2007-044669

(51) Int. Cl. C09K 19/00; B05D 5/06

(52) U.S. Cl. 428/1.6; 427/164

(57) ABSTRACT

An aspect of the present invention defines the composition and the physical properties of a coating solution so that drying unevenness is not caused even when the coated film is dried rapidly based on the premise that the coating solution containing a liquid crystal compound is coated on a flexible strip substrate being transferred in an amount of 4.5 to 12 mL/m². In the invention, a fluoroaliphatic-group-containing polymer including prescribed repeating units and also satisfying the prescribed condition is added to a coating solution for forming an optically anisotropic layer. As a result, the fluoroaliphatic-group-containing polymer travels rapidly to the interface between the coating solution and air in initial drying after coating, stabilizing the air interface of the coated film. Use of the invention therefore prevents drying unevenness even when the coating amount is increased and the solution is rapidly dried under conditions that tend to cause drying unevenness.

### BACKGROUND OF THE INVENTION

1. Field of the Invention

The present invention relates to a method for producing an optical film and the optical film. In particular, the invention relates to an optical film that increases the viewing angle of a liquid crystal display device, enhances the visibility of a liquid crystal display device, and is applicable to large liquid crystal display devices; and a method for producing the optical film.

2. Description of the Related Art

Optical compensation sheets are used for various liquid crystal display devices for preventing images from being tinted and increasing viewing angles. In recent years, there have been suggested optical compensation sheets that have optically anisotropic layers made of discotic liquid crystal compounds on transparent substrates. The discotic liquid crystal compounds typically have large birefringences and various types of orientations. Optical compensation sheets containing discotic liquid crystal compounds thus provide optical properties that cannot be obtained by using conventional stretched birefringent films.

Such optical compensation sheets have been developed to be mainly used for 15-inch or less small-size or medium-size liquid crystal display devices. But, recently, it has been necessary that the sheets are developed so that the sheets may be also used for 17-inch or more large-size and high-brightness liquid crystal display devices.

In this case, mounting conventional optical compensation sheets on the polarizing plates of large-size liquid crystal display devices as protective films often results in unevenness on the panels of the devices. This defect is not so obvious in small-size or medium-size liquid crystal display devices, but the defect is no longer negligible as larger and brighter liquid crystal display devices have been developed. Thus, there is an urgent need for an optical film with which unevenness caused by light leakage can be overcome.

In order to prevent generation of such drying unevenness or streaks, slow coating and slow drying are typically conducted by combining bar coating and air drying.

By the way, as larger optical compensation sheets are manufactured, more stringent requirements of quality without unevenness have been imposed on the sheets. There is also a desire for fast coating and fast drying in order to increase productivity of the sheets. To meet such requirements, as disclosed in Japanese Patent Application Laid-Open No. 2006-91205, the present inventors suggested to prevent drying unevenness by combining slot die coating and condensation dryer drying with which fast coating and fast drying can be conducted and by adding a fluoroaliphatic-group-containing polymer to a coating solution for forming an optically anisotropic layer.

### SUMMARY OF THE INVENTION

The light leakage unevenness is, however, not always caused in drying process, and coating failure such as coating distribution in coating process can remain as unevenness. Thus a precise coating has to be conducted rapidly.

In order to conduct a precise coating rapidly, uniformly ejecting a coating solution from the slot of a slot die is required by decreasing the solution density of the coating solution to be coated on a substrate to decrease the viscosity of the solution. In this case, to form an optically anisotropic layer having the same film thickness as before, coating amount has to be increased for compensating the decrease of the solution density of the coating solution. This can promote generation of drying unevenness in drying process particularly when fast drying is conducted by using condensation dryer or the like in an initial drying where the concentration of a solvent is high.

In this way, when an optically anisotropic layer is formed by coating an increased amount of a coating solution to a flexible strip substrate being transferred, and subsequently drying the coating solution rapidly, it has turned out that the problem of drying unevenness is not overcome sufficiently by the method disclosed in Japanese Patent Application Laid-Open No. 2006-91205 and thus the method needs to be improved.

The present invention has been accomplished under these circumstances, and an object of the present invention is to provide a method for producing an optical film and the optical film with which drying unevenness can be prevented even when a coating solution is used in fast coating and fast drying, and thus unevenness is not caused and high quality image can be displayed even when the film is applied to large-size liquid crystal display devices.

In order to achieve the object, a first aspect of the present invention provides a method for producing an optical film comprising steps of coating a coating solution containing a liquid crystal compound on a flexible strip substrate being transferred in an amount of 4.5 to 12 mL/m², and subsequently drying and curing the coating solution to form an optically anisotropic layer,

wherein the coating solution contains a fluoroaliphatic-group-containing polymer including repeating units derived from monomers in the following (i), and the coating solution also satisfies the following condition (ii).

(i) the fluoroaliphatic-group-containing polymer is a fluoroaliphatic-group-containing copolymer including a first fluoroaliphatic-group-containing monomer having an end structure represented by —(CF₂CF₂)₃F, and a second fluoroaliphatic-group-containing monomer having an end structure represented by —(CF₂CF₂)₂F.

(ii) the coating solution has a surface tension ratio between surface tensions after 10 milliseconds and after 1000 milliseconds (surface tension after 10 milliseconds/surface tension after 1000 milliseconds) of 1.0 to 1.2 determined by maximum bubble pressure method when a product of C and F is 0.05 to 0.12 where C represents concentration (percent by mass) of the fluoroaliphatic-group-containing polymer in the coating solution and F represents fluorine content (percent) in the fluoroaliphatic-group-containing polymer.

The invention of the first aspect defines the composition and the physical properties of a coating solution so that drying unevenness is not caused even when the coated film is dried rapidly based on the premise that the coating solution containing a liquid crystal compound is coated on a flexible strip substrate being transferred in an amount of 4.5 to 12 mL/m². In the invention, a fluoroaliphatic-group-containing polymer including repeating units in the (i) and also satisfying the (ii) is added to a coating solution for forming an optically anisotropic layer. As a result, the fluoroaliphatic-group-containing polymer travels rapidly to the interface between the coating solution and air in initial drying after coating, stabilizing the air interface of the coated film. Use of the invention therefore prevents drying unevenness even when the coating amount is increased and the solution is rapidly dried under conditions that tend to cause drying unevenness.

The product of C and F of less than 0.05 is not preferable because a liquid crystal compound in the air interface is not sufficiently controlled, causing degradation of the appearance property of an optical film such as unevenness. On the other hand, the product of C and F of greater than 0.12 is not preferable because sufficient coating properties are not obtained and problems such as cissing defects are caused in coating a coating solution containing a liquid crystal compound on a transparent substrate, causing degradation of the appearance property. Thus, by adjusting the product of C and F within the range of the first aspect, such problems are prevented and unevenness caused in initial drying is certainly reduced.

The surface tension ratio in the (ii) is mainly a value determined at room temperature (23° C. to 25° C.). The surface tension of the coating solution can be determined by maximum bubble pressure method by using a dynamic surface tension measurement apparatus (MPT2 manufactured by LAUDA). The coating amount of the coating solution is preferably 5.0 to 6.4 mL/m².

A second aspect of the present invention according to the first aspect is characterized in that the optically anisotropic layer contains 0.05 to 1 percent by mass of the fluoroaliphatic-group-containing polymer.

According to the second aspect, the surface tension of the coating solution can be adjusted within a more appropriate range. The content of the fluoroaliphatic-group-containing polymer is based on the solid content of the coating solution without its solvent.

A third aspect of the present invention according to the first or the second aspect is characterized in that the fluoroaliphatic-group-containing polymer contains 20 to 80 percent by mass of the first fluoroaliphatic-group-containing monomer based on the total amount of the first and the second fluoroaliphatic-group-containing monomers.

A fourth aspect of the present invention according to any one of the first to the third aspects is characterized in that the total amount of the first and the second fluoroaliphatic-group-containing monomers is 20 to 50 percent by mass based on the total amount of the fluoroaliphatic-group-containing polymer.

The third and the fourth aspects show the preferred compositions of the fluoroaliphatic-group-containing polymer with which drying unevenness can be prevented more effectively.

A fifth aspect of the present invention according to any one of the first to fourth aspects is characterized in that the first and the second fluoroaliphatic-group-containing monomers are represented by the following monomer (i); and

the fluoroaliphatic-group-containing polymer is a fluoroaliphatic-group-containing copolymer including a repeating unit derived from the following monomer (i) and a repeating unit derived from the following monomer (ii).

(i) a fluoroaliphatic-group-containing monomer represented by the following general formula [1]

(ii) poly(oxyalkylene)acrylate and/or poly(oxyalkylene)methacrylate general formula [1]

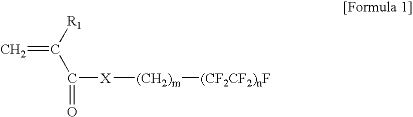

wherein R₁ represents a hydrogen atom or a methyl group; X represents an oxygen atom, a sulfur atom, or —N(R₂)—; m represents an integer of 1 to 6 inclusive; and n represents an integer of 2 or 3; and R₂ represents a hydrogen atom or an alkyl group having 1 to 4 carbon atoms.

A sixth aspect of the present invention according to the fifth aspect is characterized in that the fluoroaliphatic-group-containing polymer is a fluoroaliphatic-group-containing copolymer including a repeating unit derived from the following monomer (i), a repeating unit derived from the following monomer (ii), and a repeating unit derived from the following monomer (iii).

(i) a fluoroaliphatic-group-containing monomer represented by the general formula [1] in the fifth aspect

(ii) poly(oxyalkylene)acrylate and/or poly(oxyalkylene)methacrylate

(iii) a monomer represented by the following general formula [2] that is copolymerizable with the (i) and (ii)

general formula [2]

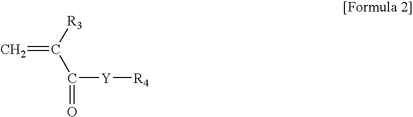

wherein R₃ represents a hydrogen atom or a methyl group; Y represents a divalent coupling group; and R₄ represents a linear, branched, or cyclic alkyl group that comprises 4 to 20 carbon atoms inclusive and may optionally comprise a substituent.

A seventh aspect of the present invention according to any one of the first to the sixth aspects is characterized in that the drying rate of the coating solution is 0.4 to 1.1 [g/(m²·sec)].

Use of the present invention is particularly advantageous in conducting such fast drying, where drying unevenness is often caused. More preferably, the drying rate of the coating solution is 0.54 to 1.07 [g/(m²·sec)].

An eighth aspect of the present invention according to any one of the first to the seventh aspects is characterized in that the coating solution is coated by using a slot die.

When a slot die is used, the coating amount has to be increased to decrease the solution density of the coating solution. Even in such a case, drying unevenness in initial drying can be prevented.

A ninth aspect of the present invention according to any one of the first to the eighth aspects is characterized in that the liquid crystal compound is a discotic compound.

A tenth aspect of the present invention provides an optical film produced by the method for producing an optical film according to any one of the first to the ninth aspects.

Use of the present invention prevents drying unevenness even when a coating solution is used in fast coating and fast drying. Use of the present invention thus provides an optical film with which unevenness is not caused and high quality image can be displayed even when the film is applied to large-size liquid crystal display devices.

### BRIEF DESCRIPTION OF THE DRAWINGS

FIG. 1 is a conceptual view of an example of an apparatus for producing an optical film to which a method for producing an optical film according to the present invention is applied;

FIG. 2 is a conceptual view of another example of an apparatus for producing an optical film to which a method for producing an optical film according to the present invention is applied;

FIG. 3 is a conceptual view of still another example of an apparatus for producing an optical film to which a method for producing an optical film according to the present invention is applied;

FIG. 4 is a schematic view of twisted hybrid orientation of discotic liquid crystal molecules in an example of an optical compensation film to which the present invention is applied;

FIG. 5 is a table showing the compositions of the coating solutions in the present examples;

FIG. 6 is a table showing the results of the present examples;

FIG. 7 is a graph showing the results of the present examples; and

FIG. 8 is a table showing the results of the present examples.

### DETAILED DESCRIPTION OF THE PREFERRED EMBODIMENTS

Hereinafter, there are described preferred embodiments of a method for producing an optical film and the optical film according to the present invention with referring to the attached drawings.

First, there is described the method for producing an optical film according to the present invention.

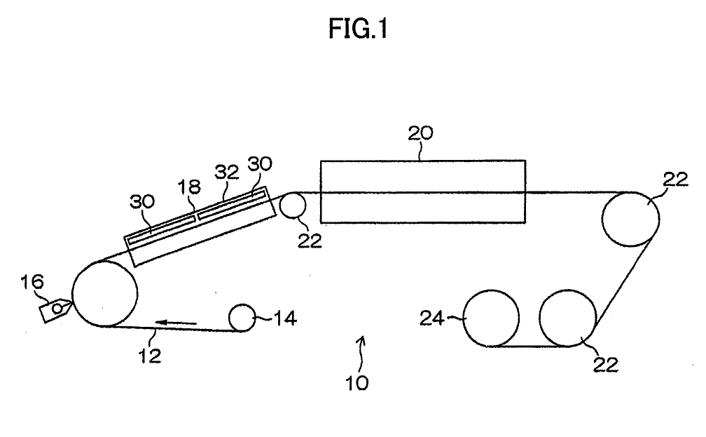

FIG. 1 is a conceptual view of an example of an apparatus 10 for producing the optical film. As shown in FIG. 1, the apparatus 10 for producing an optical film is mainly composed of a delivery device 14 which delivers a flexible strip substrate 12 wound into a roll; a slot die 16 (coating device) which coats a coating solution on the flexible strip substrate (hereinafter, referred to as “web 12”); a dryer 18 which condenses and collects solvent in the coating solution coated on the web 12 to form a coated film; a circulation drying device 20 which dries the coated film; a winding device 24 which winds a product produced by the coating and the drying; and many guide rollers 22 which form a conveying route through which the web 12 is transferred. Note that the circulation drying device 20 may be provided if necessary.

In the present invention, in order to operate coating and drying lines rapidly, initial drying process preferably employs a method of drying a coated film by condensing and collecting solvent by using a condensation plate without blowing air, which method is referred to as condensation dryer drying or heat drying.

The slot die 16 is preferably used in view of conducting fast coating, and the slot dies known and used in the art may be used. The coating amount is preferably in the range of 4.5 to 12 mL/m², and more preferably in the range of 5.0 to 6.4 mL/m².

The apparatus may be configured so that the coating surface of the substrate faces up relative to the horizontal direction as shown in FIG. 1, the surface faces down relative to the horizontal direction, or the surface is tilted relative to the horizontal direction.

The dryer 18 comprises a casing 32 composed of a condensation plate 30, a side plate, and the like. The condensation plate 30 is a plate member provided in parallel with the web 12 at a predetermined distance. The side plate is provided in a downward direction from the front or the rear of the condensation plate 30. As a result, in the dryer, when solvent evaporates from the coating solution forming a coated film, the evaporated solvent is condensed on the condensation plate 30 and collected.

In the dryer 18, the coating surface and the condensation plate 30 form space therebetween as if the space was interposed between two plates. The solvent evaporates into the space and the evaporated solvent is collected from the condensation surface of the condensation plate 30. In order to dry the coating surface uniformly, uniform mass transfer and heat transfer have to be achieved by forming a boundary layer without turbulence between the coating surface and the condensation plate 30. To meet this condition, the temperatures of the coating surface and the condensation plate 30 and the distance between the coating surface and the condensation plate 30 are set.

The material of the surface of the condensation plate 30 facing the coated film surface is not particularly restricted and material such as metal, plastic, or wood may be used. However, when the coating solution contains an organic solvent, it is preferred that material resistant to the organic solvent is used or a coating is applied to the surface of the condensation plate 30.

As for a device which collects the solvent condensed on the condensation plate 30, for example, the solvent can be collected by using capillary force obtained by forming grooves on the condensation surface of the condensation plate 30. The grooves may be formed along the direction to which the web 12 is transferred, or may be formed orthogonally to the direction. When the condensation plate 30 is tilted, the grooves are preferably formed in a direction so that the solvent can be collected easily.

Other than the configuration where the condensation plate 30, which is a plate member, is employed as the dryer 18, other configurations providing the similar function may also be used such as a configuration using a porous plate, a net, a slit plate, a roll, or the like. The dryer 18 may also used in combination with a collecting device disclosed in U.S. Pat. No. 5,694,701.

The dryer 18 is preferably provided as near as possible to the coating device 16 in order to prevent the drying unevenness of a coated film caused by natural convection generated immediately after a coating solution is coated. Specifically, the dryer 18 is preferably provided so that the entrance of the dryer 18 is positioned within 5 meters from the coating device 16, more preferably within 2 meters from the coating device 16, and still more preferably within 0.7 meters from the coating device 16.

When the transfer rate of the web 12 is too large, entrained wind disturbs a boundary layer close to the coated film, resulting in adverse impact on the coated film. Therefore, the transfer rate of the web 12 is preferably set at from 4 to 120 m/min, more preferably at from 24 to 80 m/min, and still more preferably at from 40 to 70 m/min.

The unevenness of a coated film tends to be generated particularly in the initial phase of drying. It is therefore preferred that the dryer 18 condenses and collects 10% or more of the solvent in a coating solution, and the remainder of the coating solution is dried by using the circulation drying device 20. How much percent of the solvent in a coating solution is condensed and collected is decided by comprehensively assessing impact on the drying unevenness of a coated film, production efficiency, and the like.

The apparatus is preferably equipped with a heating device which heats the web 12 and/or the coated film, and a cooling device which cools the condensation plate 30 in order to accelerate evaporation and condensation of the solvent in a coating solution, thereby increasing drying rate. In order to set the drying rate within an appropriate range, one of the heating device and the cooling device may be used, or both of the heating device and the cooling device may also be used.

The cooling device and the heating device are preferably configured so that temperatures can be adjusted. Examples of the cooling device for the condensation plate 30 may include heat exchanger type with water cooling type using a coolant or the like, air cooling type using air, and electric type such as a type using a Peltier device.

Examples of the heating device which heats the web 12 and/or the coated film may include a heater, a transfer roll (a heating roll) where temperature can be increased, an infrared heater, and a microwave heating device.

In the condensation drying in the dryer 18, the drying rate is preferably 0.4 to 1.1 [g/(m²·sec)], and more preferably 0.54 to 1.07 [g/(m²·sec)].

The temperatures of the web 12, the coated film, and the condensation plate 30 have to be set so that the evaporated solvent does not form condensation in positions other than the condensation plate 30 such as the surface of the transfer roll. Therefore, for example, it is preferred that the temperatures of the portions other than the condensation plate 30 are set higher than the temperature of the condensation plate 30.

As for the circulation drying device 20, roller transfer dryer type or air floating dryer type drying devices may be used, which devices are conventionally used. The both types of drying devices share that a coated film is dried by providing dry air to the surface of the coated film. It is also possible that coated film is dried by using only the dryer 18 without providing the circulation drying device 20.

Up to this point, there has been described an embodiment of an apparatus for producing an optical film to which a method for producing an optical film according to the present invention is applied. The present invention is, however, not restricted to the embodiment.

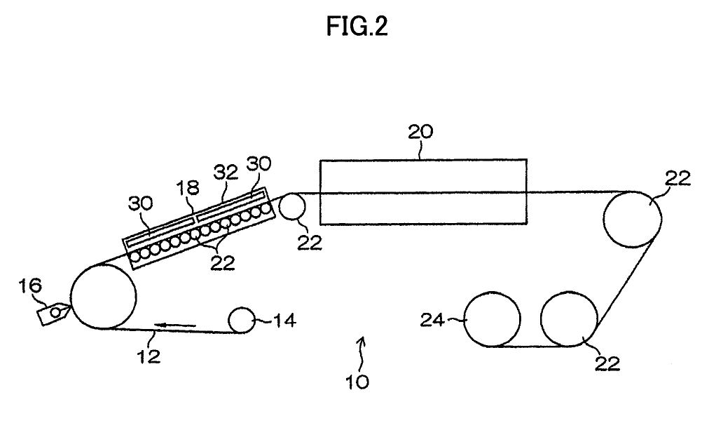

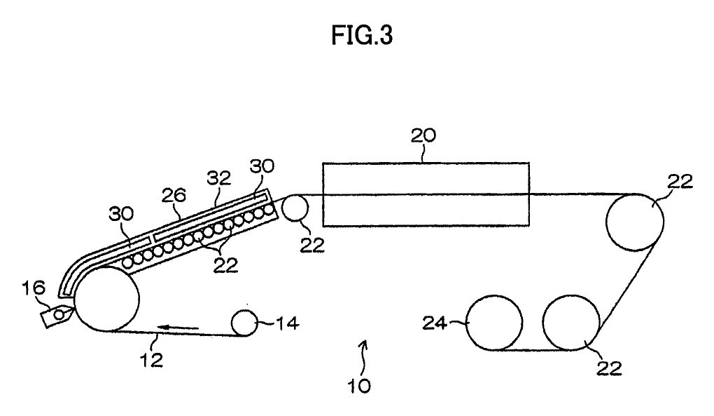

FIGS. 2 and 3 show other configuration examples of the production apparatus 10. As shown in FIG. 2, in the dryer 18, many guide rollers 22 may be provided on the opposite side of the condensation plate 30 relative to the web 12 interposed between the rollers 22 and the plate 30.

The dryer 18 is not necessarily linear-shaped as shown in FIG. 1, and an arc-shaped dryer 26 shown in FIG. 3 may also be used. It is also possible to provide a large drum and to provide a dryer on the drum. In FIG. 3, the arc-shaped dryer 26 is positioned close to the coating device 16 to increase the efficiency of collecting solvent.

The present embodiment has been described in relation to an example employing condensation drying (heat drying) as the initial fast drying. However, the present invention is not restricted to the embodiment, and other drying devices may also be used with which the coating solution can be dried at the drying rate mentioned above.

As mentioned above, the production apparatus 10 with which fast coating and drying are conducted generally employs a slot die, which is suitable for fast coating. But, because of the constraints of the apparatus configuration, the apparatus is not suitable for a coating solution having high viscosity and high density. Therefore, the density of the coating solution is decreased than the densities of conventional coating solutions, and to compensate the decreased density, the coating amount of the coating solution is increased.

As a result of increase of the coating amount, drying energy also has to be increased. Drying unevenness is therefore more likely generated.

In the present invention, to prevent such drying unevenness, enhancing the levelling of the coating solution on the web 12 is important by properly adjusting the surface tension of the coating solution.

The present inventors have found that there is a close relationship between the surface tension of a coating solution and the chemical structure of a fluoroaliphatic-group-containing polymer added to the coating solution, specifically the end structure of at least one fluoroaliphatic-group-containing monomer forming the fluoroaliphatic-group-containing polymer.

That is, the surface tension of a coating solution can be decreased by forming a fluoroaliphatic-group-containing polymer as a copolymer at least comprising a first fluoroaliphatic-group-containing monomer having an end structure represented by —(CF₂CF₂)₃F, and a second fluoroaliphatic-group-containing monomer having an end structure represented by —(CF₂CF₂)₂F.

Other than the end structures, the fluoroaliphatic-group-containing polymer is not particularly restricted, and the polymer may include various repeating units. Specific examples of the fluoroaliphatic-group-containing polymer used in the present invention are mentioned later.

The present inventors also have found that the coating solution is suitable for forming an optically anisotropic layer when the coating solution has a surface tension ratio between surface tensions after 10 milliseconds and after 1000 milliseconds (surface tension after 10 milliseconds/surface tension after 1000 milliseconds) of 1.0 to 1.2 determined by maximum bubble pressure method when a product of C and F is 0.05 to 0.12 where C represents concentration (percent by mass) of the fluoroaliphatic-group-containing polymer in the coating solution and F represents fluorine content (percent) in the fluoroaliphatic-group-containing polymer.

That is, when the surface tension ratio is greater than 1.2, the polymer travels slowly to the interface between the coating solution and air immediately after coating, resulting in the insufficient stability of the surface of the coated film at the air interface. Thus the effect of reducing unevenness in initial drying is not sufficiently obtained. When the surface tension ratio is in the range of 1.0 to 1.2, such a problem does not occur, and unevenness in initial drying can be further reduced.

The content of a fluoroaliphatic-group-containing polymer according to the present invention is preferably in the range of 0.05 to 1 percent by mass based on a coating composition (coating components without solvent) mainly containing a liquid crystal compound, more preferably in the range of 0.1 to 0.5 percent by mass. When the amount of the fluoroaliphatic-group-containing polymer to be added is less than 0.05 percent by mass, the effect of enhancing the levelling property of a coating solution is not sufficiently obtained. When the amount is greater than 1 percent by mass, the polymer has adverse impact on the properties of an optical film such as uniformity of retardation.

Next, there is described a fluoroaliphatic-group-containing polymer used in the present invention.

Hereinafter, there are described in detail examples of a copolymer including a repeating units derived from a fluoroaliphatic-group-containing monomer represented by the general formula [1]. The fluoroaliphatic-group-containing polymers used in the present invention, however, are not restricted to the examples.

One of the fluoroaliphatic groups forming a fluoroaliphatic-group-containing polymer according to the present invention is derived from a fluoroaliphatic compound produced by telomerization method (also referred to as telomer method) or oligomerization method (also referred to as oligomer method). These methods for producing fluoroaliphatic compounds are described, for example, in “Synthesis and Function of Fluorine Compounds” (Nobuo Ishikawa, editor), pp. 117-118, CMC (1987), and “Chemistry of Organic Fluorine Compounds II” Monograph 187, Ed by Milos Hudlicky and Attila E. Pavlath, pp. 747-752, American Chemical Society (1995). The teromerization is a method where a fluorine-containing vinyl compound such as tetrafluoroethylene is radical-polymerized using an alkyl halide having a large chain transfer constant, such as iodide, as a terogen to synthesize a teromer (one example is shown in Scheme-1).

### [Formula 3]

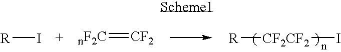

Thus obtained end iodinated teromer is typically subjected to an appropriate end chemical modification, for example, modification shown in [Scheme 2] and derived to a fluoro-aliphatic compound. These compounds are, if desired, further converted into desired monomer structures and used for the production of a fluoroaliphatic group-containing polymer.

### [Formula 4]

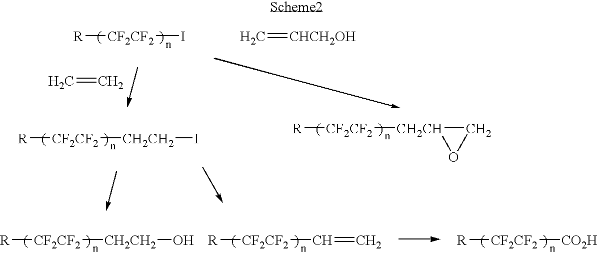

In the general formula [1] of the present invention, R₁ represents a hydrogen atom or a methyl group; X represents an oxygen atom, a sulfur atom, or N(R₂)—; R₂ represents a hydrogen atom or an alkyl group having 1 to 4 carbon atoms, specifically, methyl group, ethyl group, propyl group or butyl group, and preferably represents a hydrogen atom or a methyl group. X preferably represents an oxygen atom.

In the general formula [1], m preferably represents an integer of 1 to 6 inclusive, and particularly preferably 2. In the general formula [1], n represents 2 to 4, particularly preferably 2 or 3, and a mixture thereof may also be used.

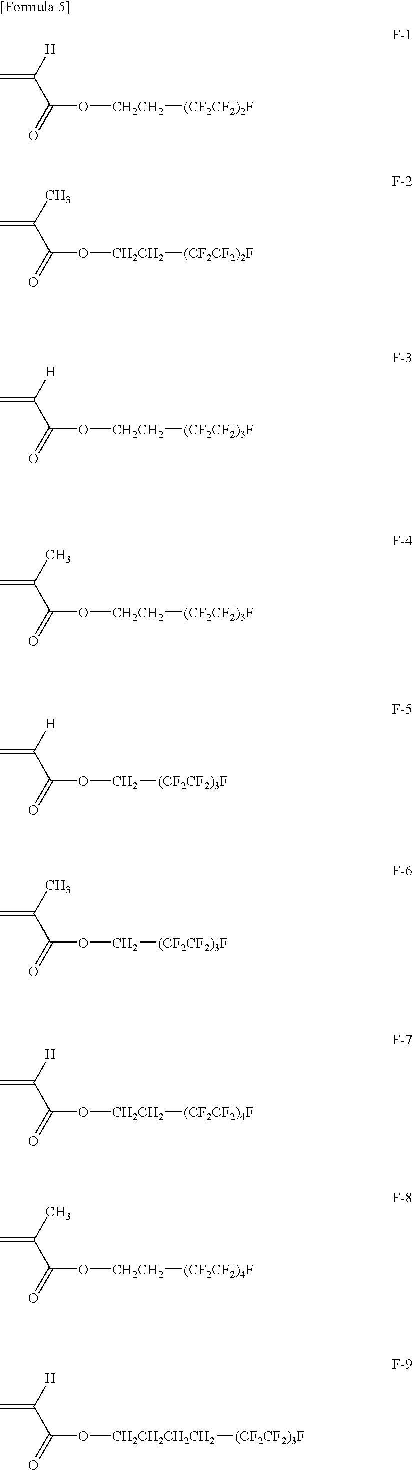

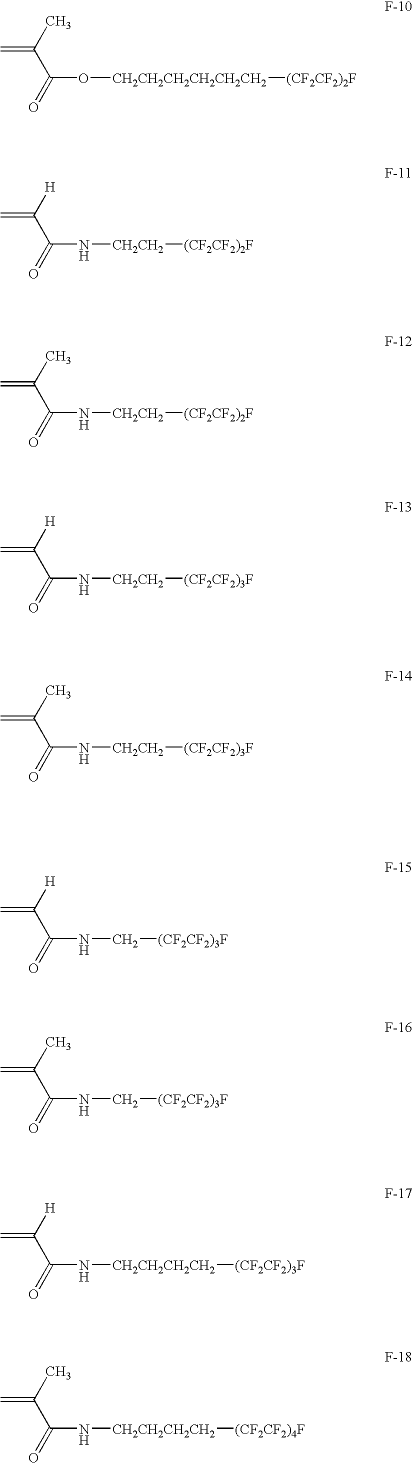

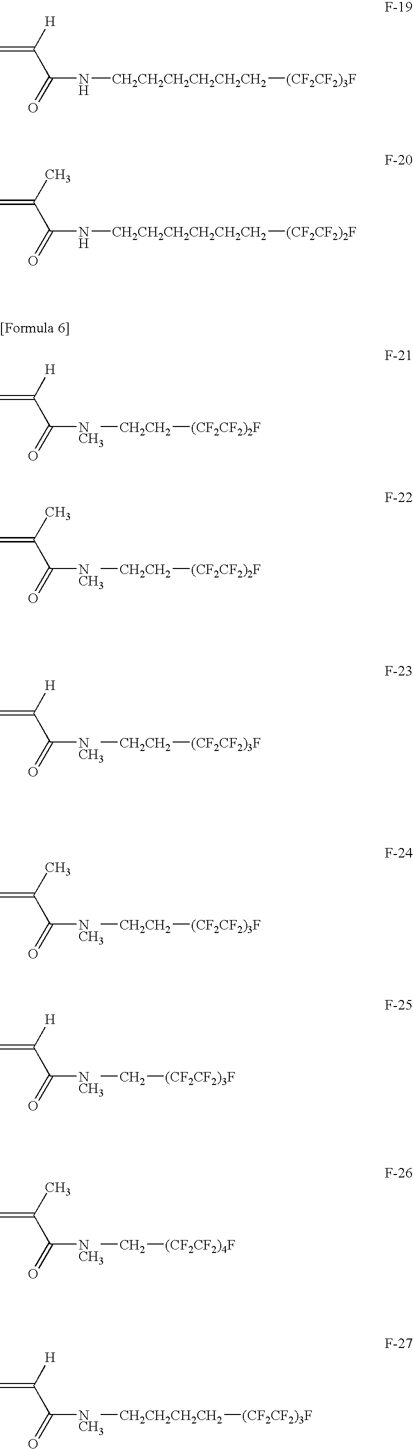

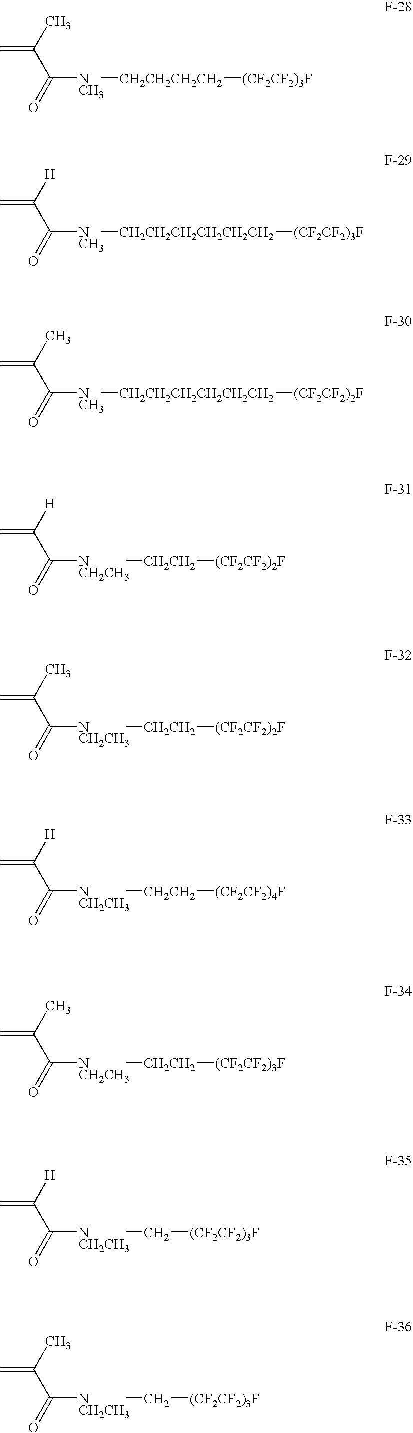

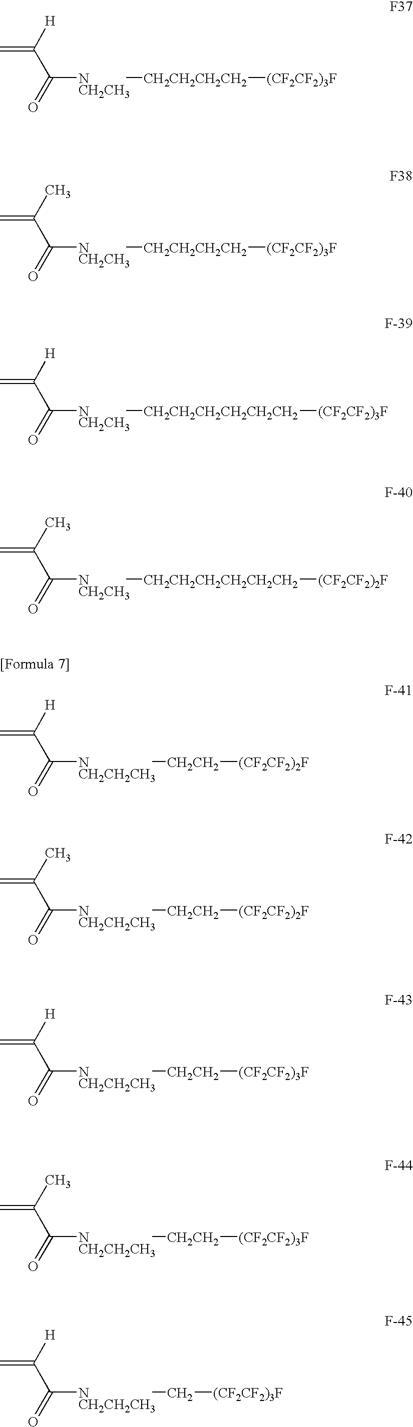

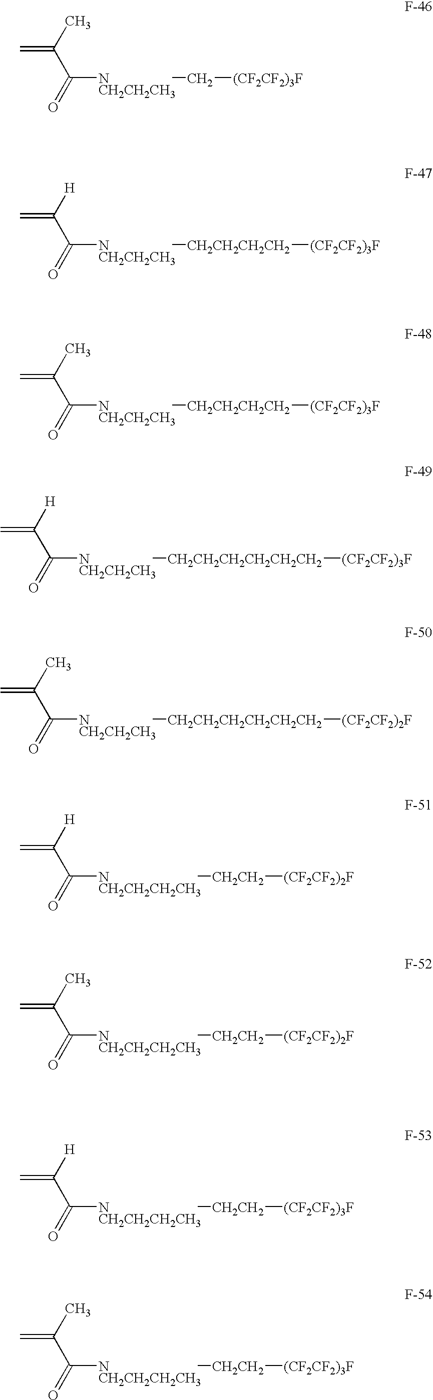

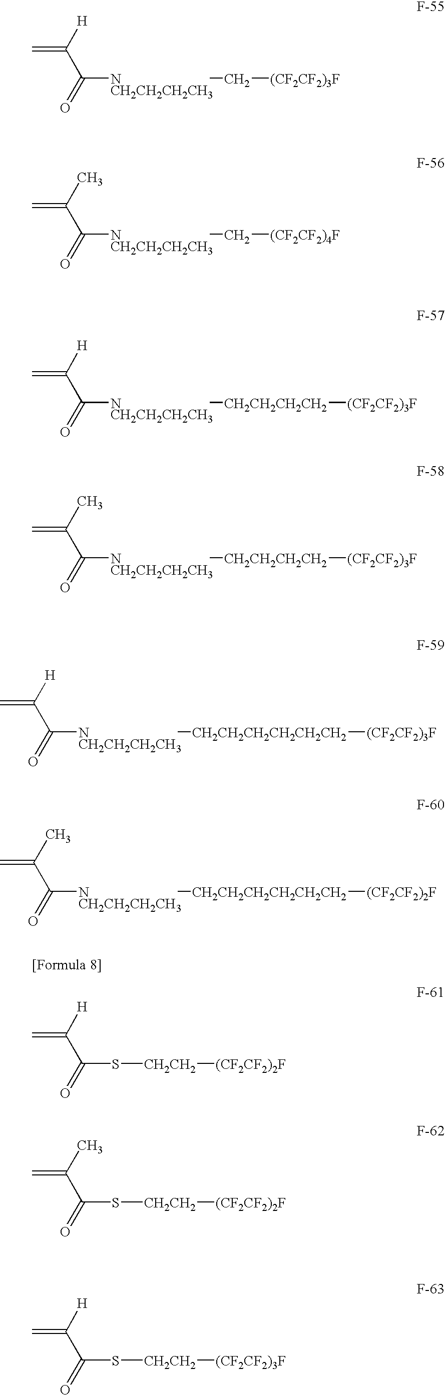

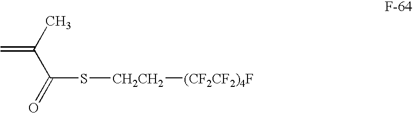

In the general formula [2], R₃ represents a hydrogen atom or a methyl group; Y represents a divalent coupling group. The divalent coupling group is preferably an oxygen atom, a sulfur atom or —N(R₅)—, wherein R₅ is preferably a hydrogen atom or an alkyl group having from 1 to 4 carbon atoms such as methyl group, ethyl group, propyl group or butyl group, and more preferably a hydrogen atom or a methyl group. Y is more preferably an oxygen atom, —N(H)— or —N(CH₃)—.

R₄ represents a linear, branched, or cyclic alkyl group that comprises 4 to 20 carbon atoms inclusive and may optionally comprise a substituent. Non-limiting examples of the substituent of the alkyl group of R₄ may include: a hydroxyl group, an alkylcarbonyl group, an arylcarbonyl group, a carboxyl group, an alkyl ether group, an aryl ether group, a halogen atom such as fluorine, chlorine and bromine, a nitro group, a cyano group and an amino group. Suitable examples of the linear, branched or cyclic alkyl group having from 4 to 20 carbon atoms inclusive may include a butyl group, pentyl group, hexyl group, heptyl group, octyl group, nonyl group, decyl group, undecyl group, dodecyl group, tridecyl group, tetradecyl group, pentadecyl group, octadecyl group, or eicosanyl group, a monocyclic cycloalkyl group such as cyclohexyl group and cycloheptyl group, and a polycyclic cycloalkyl group such as bicycloheptyl group, bicyclodecyl group, tricycloundecyl group, tetracyclododecyl group, adamantyl group, norbornyl group, and tetracyclodecyl group.

Non-limiting specific examples of the monomer represented by the general formula [2] are set forth below.

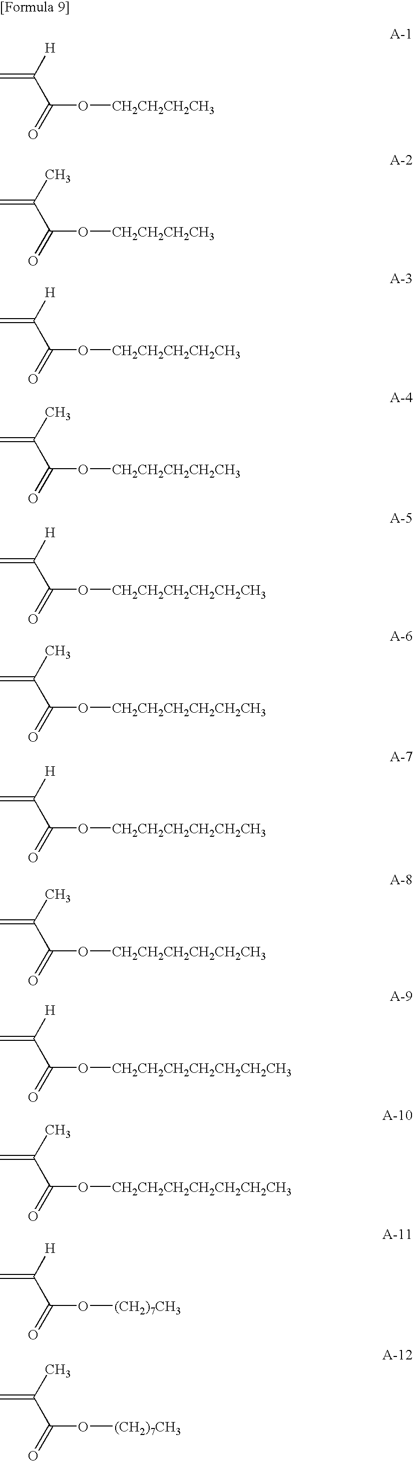

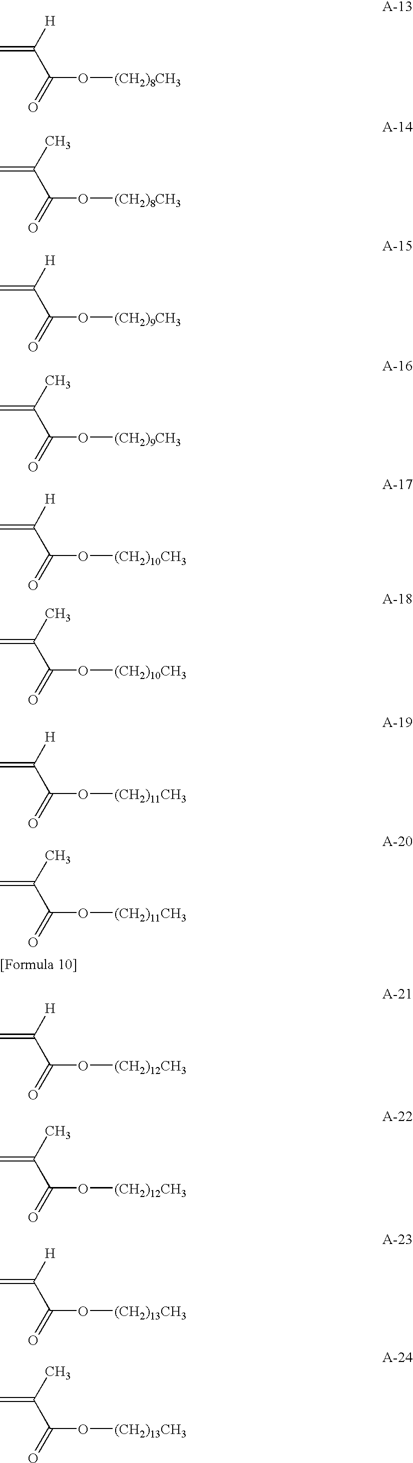

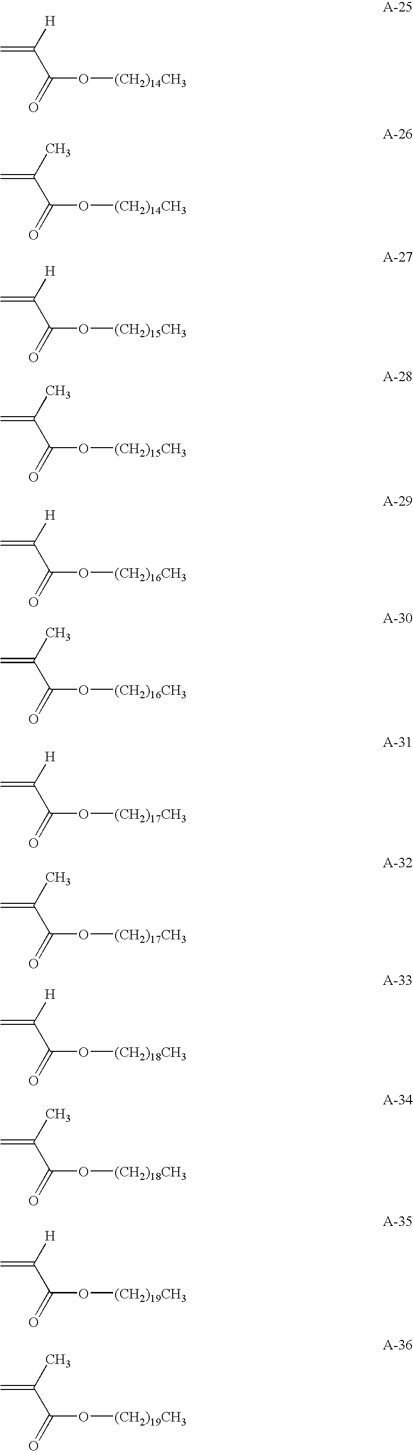

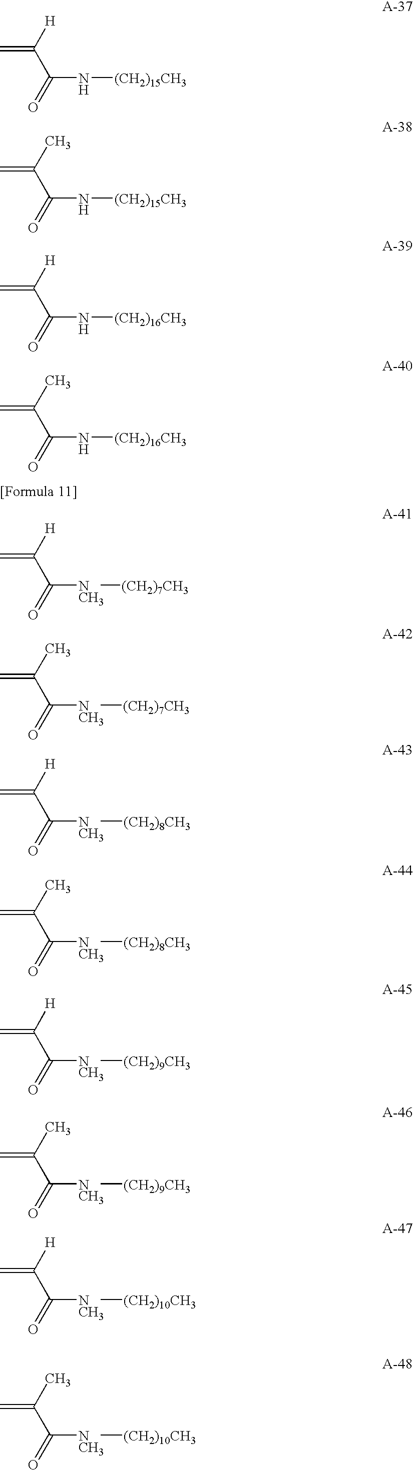

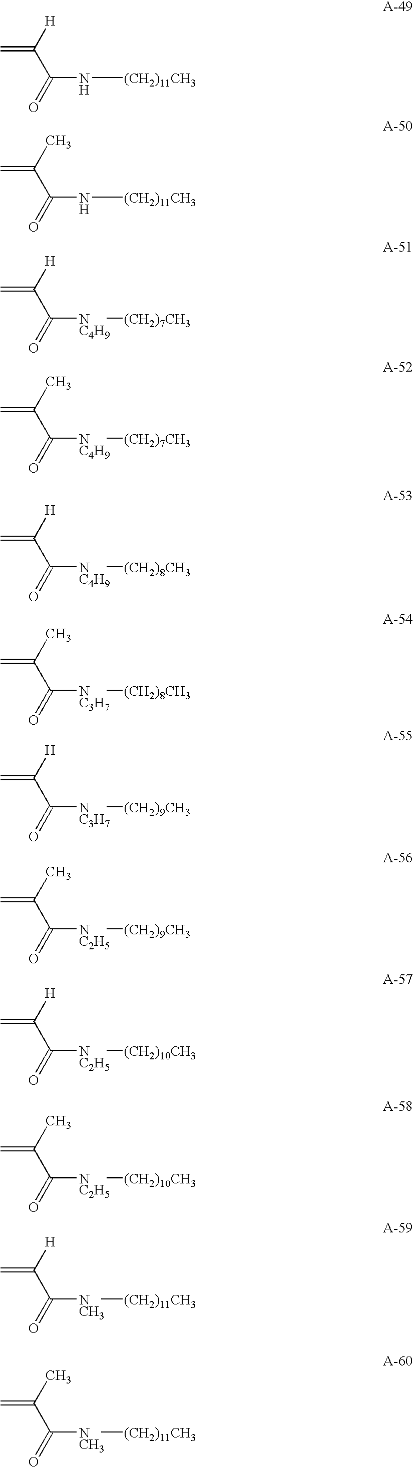

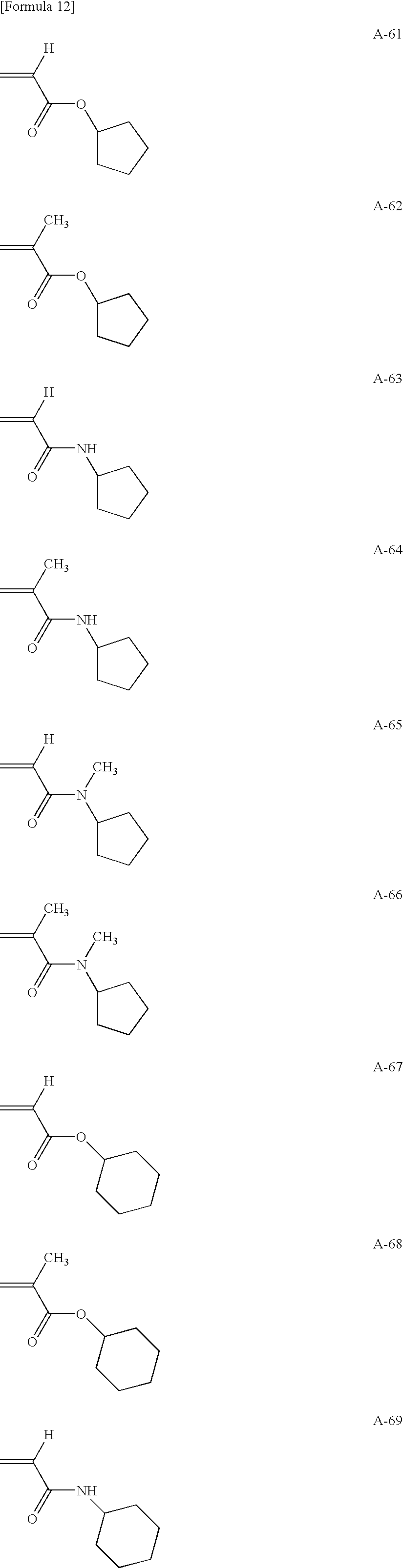

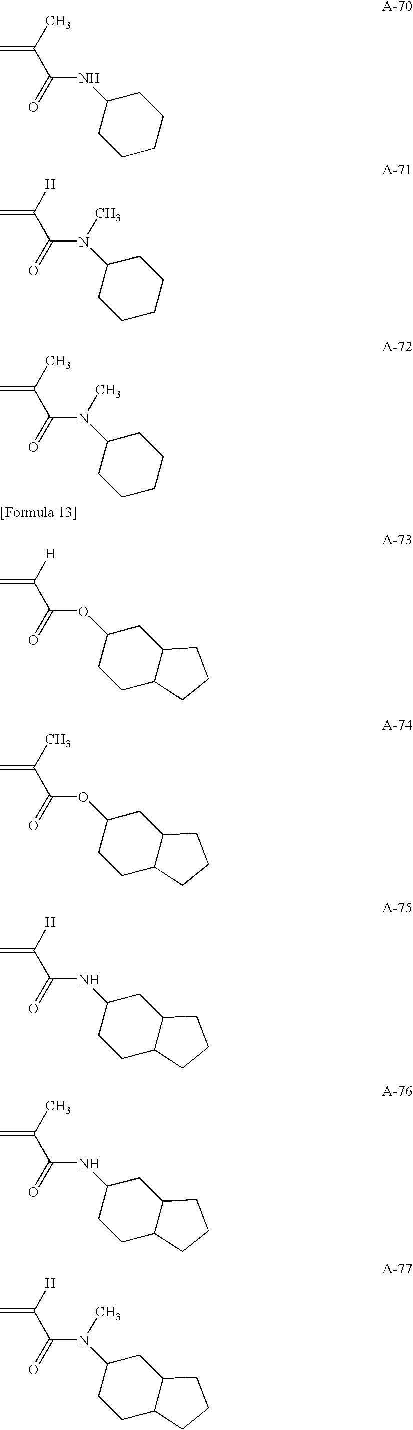

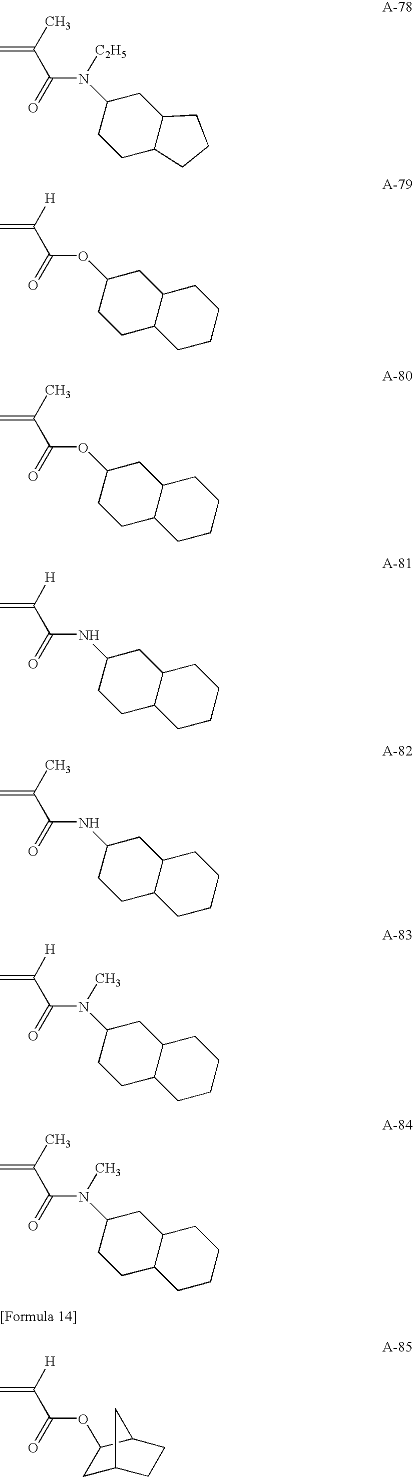

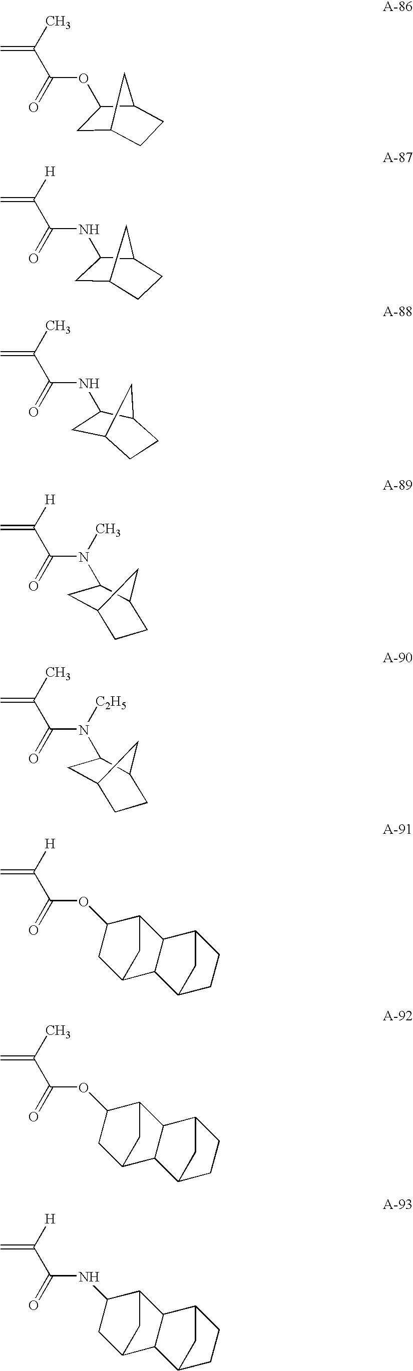

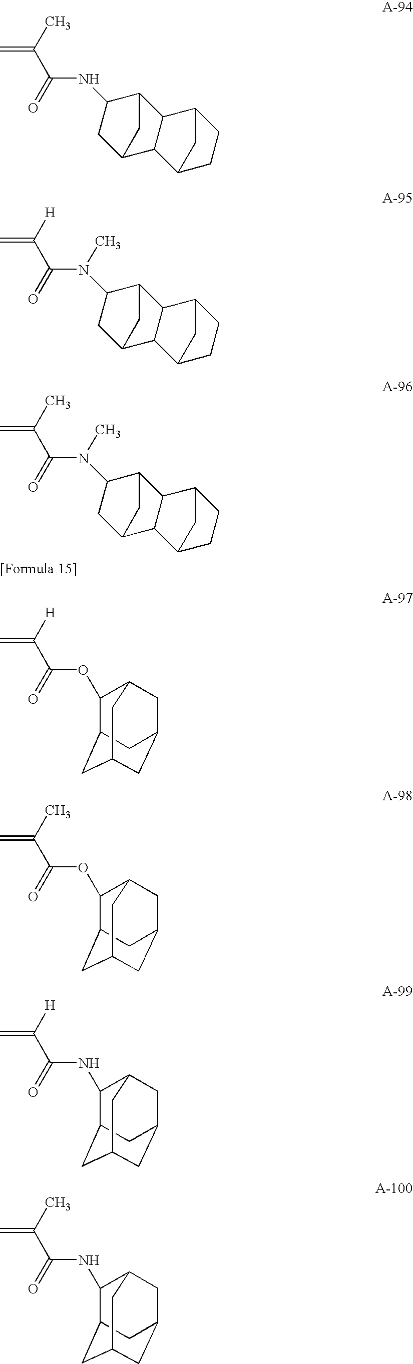

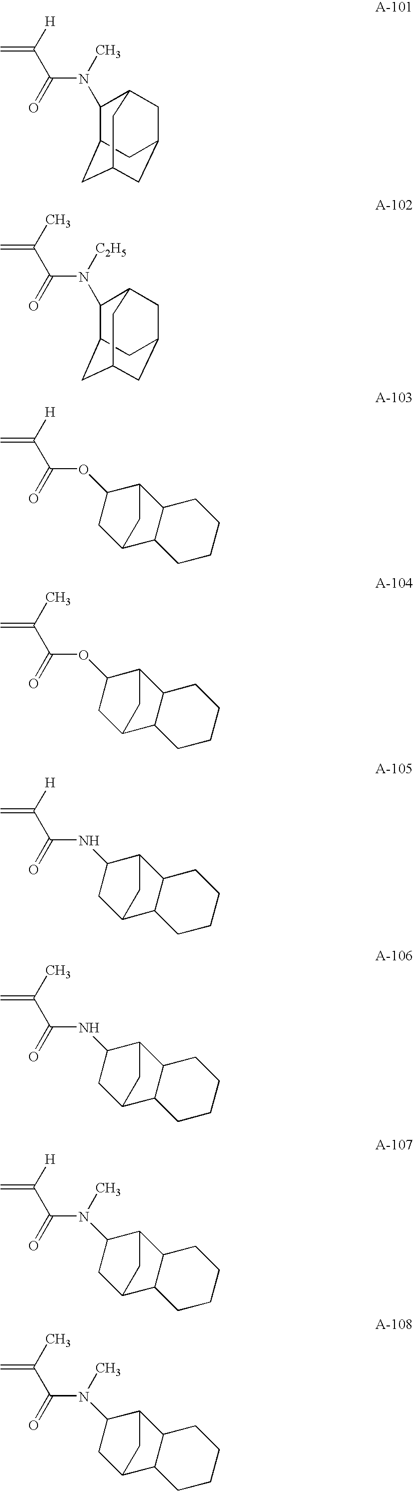

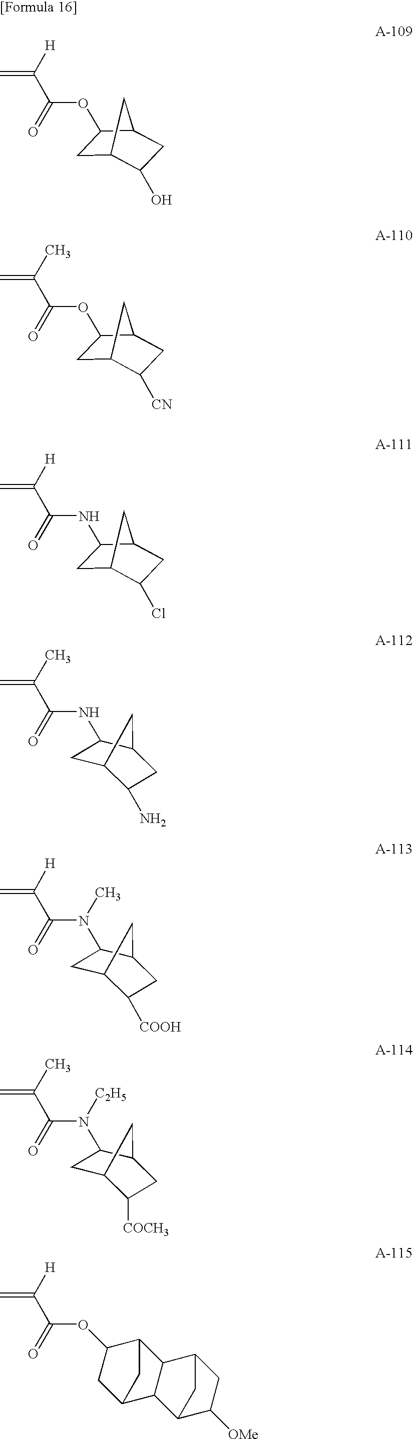

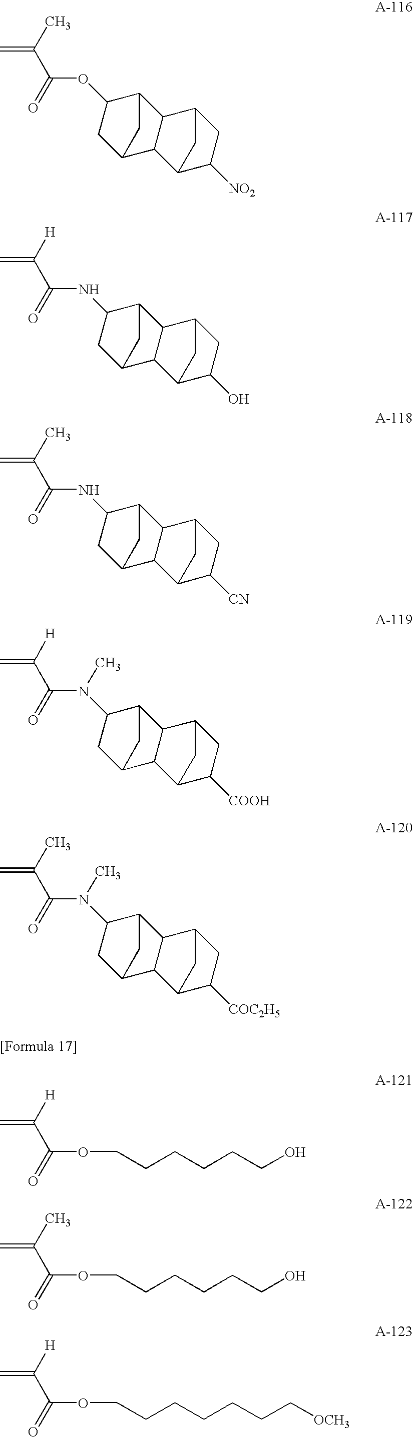

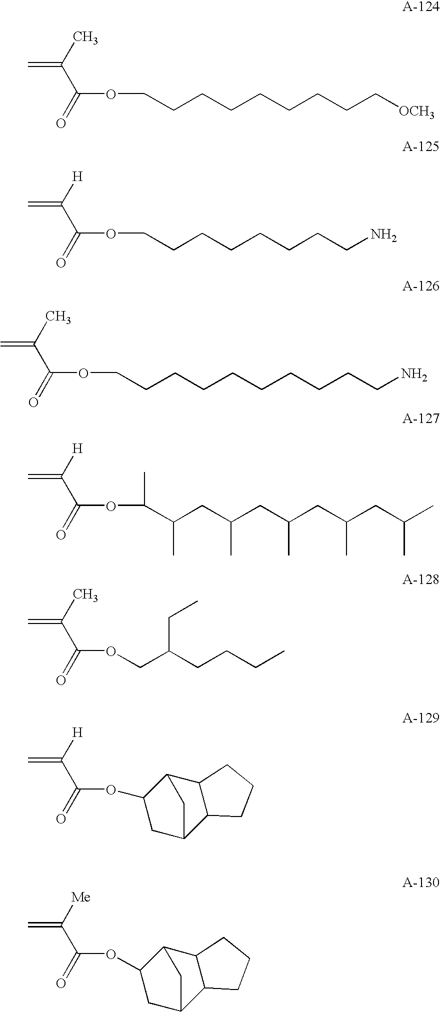

Next, there are described poly(oxyalkylene)acrylate and/or poly(oxyalkylene)methacrylate, which are other components constituting a fluoroaliphatic-group-containing polymer. Hereinafter, acrylate and methacrylate are sometimes collectively referred to as (meth)acrylate.

The polyoxyalkylene group can be represented by (OR)x, wherein R represents an alkylene group having from 2 to 4 carbon atoms and preferably, for example, —CH₂CH₂—, —CH₂CH₂CH₂—, —CH(CH₃)CH₂— or —CH(CH₃)CH(CH₃)—.

In the poly(oxyalkylene) group, the oxyalkylene units may be the same such as poly(oxypropylene), or two or more oxyalkylene units different from one another may be irregularly distributed. Also, the oxyalkylene unit may be a linear or branched oxypropylene or oxyethylene unit, or may be present as a block of linear or branched oxypropylene units or a block of oxyethylene units.

The poly(oxyalkylene) chain may contain a plurality of poly(oxyalkylene) units connected among the units via one or more linking bond, for example, —CONH-Ph-NHCO— or —S—, wherein Ph represents a phenylene group. In the case where the linking bond has three or more valences, the bond functions for obtaining a branched oxyalkylene unit. In the case of using the copolymer in the present invention, the molecular weight of the poly(oxyalkylene) group is suitably from 250 to 3,000.

The poly(oxyalkylene)acrylate or methacrylate can be produced by effecting reaction between a commercially available hydroxypoly(oxyalkylene) material, for example, a product available under the trade name “Pluronic” (produced by Asahi Denka Co., Ltd.), “Adeka Polyether” (produced by Asahi Denka Co., Ltd.), “Carbowax” (produced by Glyco Products Co.), “Toriton” (produced by Rohm and Haas Co.) or “P.E.G.” (produced by Dai-ichi Kogyo Seiyaku Co., Ltd.), and an acrylic acid, a methacrylic acid, an acryl chloride, a methacryl chloride, an acrylic anhydride, or the like by a known method. Alternatively, a poly(oxyalkylene)diacrylate or the like produced by a known method may also be used.

As for a preferred embodiment of a fluoroaliphatic-group-containing polymer used in the present invention, there is used a copolymer including a first fluoroaliphatic-group-containing monomer having an end structure represented by —(CF₂CF₂)₃F, and a second fluoroaliphatic-group-containing monomer having an end structure represented by —(CF₂CF₂)₂F in the general formula [1].

In this case, the total amount of the fluoroaliphatic-group-containing monomers represented by the general formula [1] in the fluoroaliphatic-group-containing polymer is preferably 20 to 50 percent by mass, and more preferably about 40 percent by mass, based on the total amount of the monomers constituting the fluoroaliphatic-group-containing polymer. Also, the fluoroaliphatic-group-containing polymer preferably contains 20 to 80 percent by mass of the first fluoroaliphatic-group-containing monomer based on the total amount of the first and the second fluoroaliphatic-group-containing monomers. For example, in [Formula 18] described later where b represents the content (percent by mass) of the first fluoroaliphatic-group-containing monomer, a represents the content (percent by mass) of the second fluoroaliphatic-group-containing monomer, and c represents the content (percent by mass) of polyoxyalkylene (meth)acrylate, a, b, and c preferably satisfy a:b:c=20:20:60.

As for another embodiment of a fluoroaliphatic-group-containing polymer used in the present invention, there is used a copolymer of a fluoroaliphatic-group-containing monomer represented by the general formula [1] and polyoxyethylene(meth)acrylate.

As for still another embodiment of a fluoroaliphatic-group-containing polymer used in the present invention, there is used a polymer obtained by copolymerizing three or more types of monomers among a fluoroaliphatic-group-containing monomer represented by the general formula [1], polyoxyethylene(meth)acrylate, and polyoxyalkylene(meth)acrylate. In this case, the polyoxyalkylene(meth)acrylate is a monomer different from polyoxyethylene(meth)acrylate.

More preferred is a terpolymer of polyoxyethylene(meth)acrylate, polyoxypropylene(meth)acrylate, and a fluoroaliphatic-group-containing monomer represented by the general formula [1].

A fluoroaliphatic-group-containing polymer used in the present invention may be a copolymer obtained by effecting reaction among the abovementioned monomers and additional another or other monomer(s) copolymerizable with the monomers.

The copolymerization ratio of the copolymerizable monomer(s) is preferably 20 mole % or less, more preferably 10 mole % or less, based on all monomers.

Examples of such monomers are described in Polymer Handbook, 2nd ed., J. Brandrup, Wiley Interscience (1975) Chapter 2, pp. 1-483.

Examples of the monomers may include compounds having one addition polymerizable unsaturated bond selected from acrylic acid, methacrylic acid, acrylic esters, methacrylic esters, acrylamides, methacrylamides, allyl compounds, vinyl ethers and vinyl esters.

Specific examples of the monomers may include the following monomers. Acrylic Esters:

methyl acrylate, ethyl acrylate, propyl acrylate, chloroethyl acrylate, 2-hydroxyethyl acrylate, trimethylol-propane monoacrylate, benzyl acrylate, methoxybenzyl acrylate, furfuryl acrylate, tetrahydrofurfuryl acrylate, and the like. Methacrylic Esters:

methyl methacrylate, ethyl methacrylate, propyl methacrylate, chloroethyl methacrylate, 2-hydroxyethyl methacrylate, trimethylolpropane monomethacrylate, benzyl methacrylate, methoxybenzyl methacrylate, furfuryl methacrylate, tetrahydrofurfuryl methacrylate, and the like.

### Acrylamides:

acrylamide, N-alkylacrylamide (the alkyl group is an alkyl group having from 1 to 3 carbon atoms, e.g., methyl group, ethyl group, propyl group), N,N-dialkylacrylamide (the alkyl group is an alkyl group having from 1 to 3 carbon atoms), N-hydroxyethyl-N-methylacrylamide, N-2-acetamidoethyl-N-acetylacrylamide, and the like.

### Methacrylamides:

methacrylamide, N-alkylmethacrylamide (the alkyl group is an alkyl group having from 1 to 3 carbon atoms, e.g., methyl group, ethyl group, propyl group), N,N-dialkylmethacrylamide (the alkyl group is an alkyl group having from 1 to 3 carbon atoms), N-hydroxyethyl-N-methylmethacrylamide, N-2-acetamidoethyl-N-acetylmethacrylamide, and the like.

### Allyl Compounds:

allyl esters (e.g., allyl acetate, allyl caproate, allyl caprylate, allyl laurate, allyl palmitate, allyl stearate, allyl benzoate, allyl acetoacetate, allyl lactate), allyl oxyethanol, and the like.

### Vinyl Ethers:

alkyl vinyl ethers (e.g., hexyl vinyl ether, octyl vinyl ether, decyl vinyl ether, ethylhexyl vinyl ether, methoxyethyl vinyl ether, ethoxyethyl vinyl ether, chloroethyl vinyl ether, 1-methyl-2,2-dimethylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether, tetrahydrofurfuryl vinyl ether), and the like.

### Vinyl Esters:

vinyl butyrate, vinyl isobutyrate, vinyl trimethyl-acetate, vinyl diethylacetate, vinyl valerate, vinyl caproate, vinyl chloroacetate, vinyl dichloroacetate, vinyl methoxyacetate, vinyl butoxyacetate, vinyl lactate, vinyl-β-phenylbutyrate, vinyl cyclohexylcarboxylate, and the like.

### Dialkyl Itaconates:

dimethyl itaconate, diethyl itaconate, dibutyl itaconate, and the like. Dialkyl Esters or Monoalkyl Esters of Fumaric Acid:

dibutyl fumarate, and the like.

Others: crotonic acid, itaconic acid, acrylonitrile, methacrylonitrile, maleylonitrile, styrene, and the like.

A fluoroaliphatic-group-containing polymer used in the present invention preferably contains 5 to 60 percent by mass, more preferably about 35 to 45 percent by mass, of a fluoroaliphatic-group-containing monomer represented by the general formula [1] based on the total amount of the monomers constituting the fluoroaliphatic-group-containing polymer.

The amount of the poly(oxyalkylene)acrylate and/or poly(oxyalkylene)methacrylate is preferably 40 to 95 percent by mass, more preferably 55 to 65 percent by mass, based on the total amount of the monomers constituting the fluoroaliphatic-group-containing polymer.

The weight average molecular weight of a fluoroaliphatic-group-containing polymer used in the present invention is preferably from 3,000 to 100,000, more preferably from 6,000 to 80,000.

A fluoroaliphatic-group-containing polymer used in the present invention can be produced by a conventionally and commonly employed method. For example, the polymer can be produced by adding a general-purpose radical polymerization initiator to an organic solvent containing the above-described monomers such as fluoroaliphatic group-containing (meth)acrylate and polyoxyalkylene-group-containing (meth)acrylate, and polymerizing these monomers. In some cases, the polymer can also be produced by the same method except that another addition polymerizable unsaturated compound is further added. Depending on the polymerizability of each monomer, dropping polymerization method of polymerizing monomers by dropping the monomers and the initiator in a reaction vessel is effective for obtaining a polymer having a uniform composition.

Specific structure examples of a fluoroaliphatic-group-containing polymer used in the present invention are set forth below, however, the present invention is not limited thereto. In the following formulae, the numerals represent the molar ratios of respective monomer components and Mws represent weight average molecular weights.

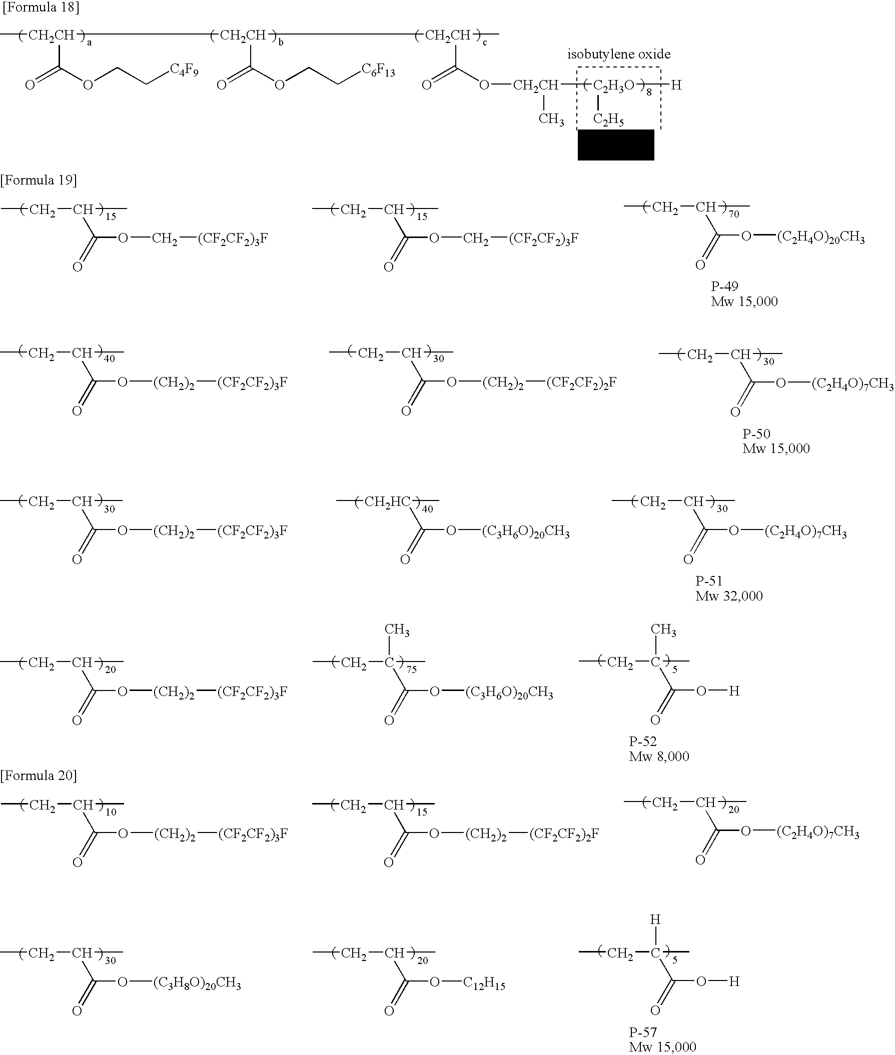

In the present invention, besides the fluoroaliphatic-group-containing polymer, it is preferred to use a fluoroaliphatic-group-containing polymer containing an acidic group (acidic-group-containing fluoroaliphatic-group-containing polymer).

Examples of the fluoroaliphatic-group-containing polymer containing an acidic group may include a fluoroaliphatic-group-containing polymer having at the end of the main chain one or more types of hydrophilic groups selected from the group consisting of a carboxyl group (—COOH), a sulfo group (—SO₃H), a phosphono group [—PO(OH)₂], and salts of the foregoing. It is preferred that the hydrophilic groups interact with the end of the main chain of the fluoroaliphatic-group-containing polymer and the groups are covalently bonded to the end. In particular, the fluoroaliphatic-group-containing polymer containing an acidic group is preferably obtained by polymerization using a chain transfer agent having the hydrophilic group(s), and more preferably obtained by polymerization using a chain transfer agent having a carboxyl group (—COOH).

A method for polymerizing the fluoroaliphatic-group-containing polymer containing an acidic group is not particularly restricted, but, for example, polymerization methods may be used such as cationic polymerization or radical polymerization using a vinyl group, or anionic polymerization. Among the methods, radical polymerization is particularly preferable because of general versatility.

As for a polymerization initiator for the radical polymerization, known radical thermal or radical photo polymerization initiators may be used, and particularly preferred are radical thermal polymerization initiators. It is noted that radical thermal polymerization initiators are compounds that generate radicals when being heated at decomposition temperatures or higher. Examples of the radical thermal polymerization initiators may include diacyl peroxides such as acetyl peroxide or benzoyl peroxide; ketone peroxides such as methyl ethyl ketone peroxide or cyclohexanone peroxide; hydro peroxides such as hydrogen peroxide, tert-butylhydro peroxide or cumenehydro peroxide; dialkyl peroxides such as di-tert-butylperoxide, dicumyl peroxide or dilauroyl peroxide; peroxy esters such as tert-butylperoxy acetate or tert-butylperoxy pivalate; azo-based compounds such as azo bis iso-butylonitrile or azo bis iso-valeronitrile and persulfates such as ammonium persulfate, sodium persulfate or potassium persulfate. Such radical thermal polymerization initiators may be used alone or in combination.

Preferred examples of a chain transfer agent used for polymerizing the fluoroaliphatic-group-containing polymer containing an acidic group may include chain transfer agents having one or more types of hydrophilic groups selected from the group consisting of a carboxyl group (—COOH), a sulfo group (—SO₃H), a phosphono group [—PO(OH)₂], and salts of the foregoing, and most preferably chain transfer agents having a carboxyl group (—COOH).

As for the types of the chain transfer agent, any of the following types may be used: mercaptans such as mercaptoacetic acid, octyl mercaptan, decyl mercaptan, dodecyl mercaptan, tert-dodecyl mercaptan, octadecyl mercaptan, thiophenol or p-nonyl thiophenol; polyhalogenated alkyls such as carbon tetrachloride, chloroform, 1,1,1-trichloroethane or 1,1,1-tribromo octane; and low-activity monomers such as α-methyl styrene or α-methyl styrene dimer. Among the types, mercaptans are preferred. The method of adding such a chain transfer agent is not particularly restricted as long as the agent is added to be present with monomers in the system. That is, the agent may be added by dissolving in monomers, or the agent and the monomers may also be added separately.

For example, when mercaptans having a hydrophilic group are used as the chain transfer agents, the fluoroaliphatic-group-containing polymer has a structure where polymer main chain and the hydrophilic group are bonded via a divalent group containing a thioether group *-S—R-** derived from the chain transfer agents. In the formula, R represents a substituted or unsubstituted alkylene group, preferably a C1-15 alkylene group, substituted or unsubstituted arylene group, or substituted or unsubstituted heterocyclic group; * represents the position where the divalent group is bonded to the polymer main chain; and ** represents the position where the divalent group is bonded to the hydrophilic group.

Specific examples of the chain transfer agents that can be used in the present invention are shown below which agents have one or more types of hydrophilic groups selected from a carboxyl group (—COOH), a sulfo group (—SO₃H), a phosphono group [—PO(OH)₂], and salts of the foregoing, but the chain transfer agents are not restricted thereto. Note that the following compounds can be synthesized, for example, by methods disclosed in U.S. Pat. No. 2,504,030.

### [Formula 21]

HSCH₂COOH c-1

HS(CH₂)₂COOH c-2

HS(CH₂)₃COOH c-3

HS(CH₂)₄COOH c-4

HS(CH₂)₅COOH c-5

HS(CH₂)₅COOH c-6

HS(CH₂)₆COOH c-7

HS(CH₂)₇COOH c-8

HS(CH₂)₈COOH c-9

HS(CH₂)₉COOH c-10

HS(CH₂)₁₀COOH c-11

HS(CH₂)₁₁COOH c-12

HS(CH₂)₁₂COOH c-13

HS(CH₂)₁₃COOH c-14

HS(CH₂)₁₄COOH c-15

HS(CH₂)₁₅COOH c-16

CH₃CH(SH)COOH c-17

HSCH₂CH₂COCONa c-18

HSCH₂CH₂COCONa c-19

HO₂CCH₂CH(SH)COOH c-20

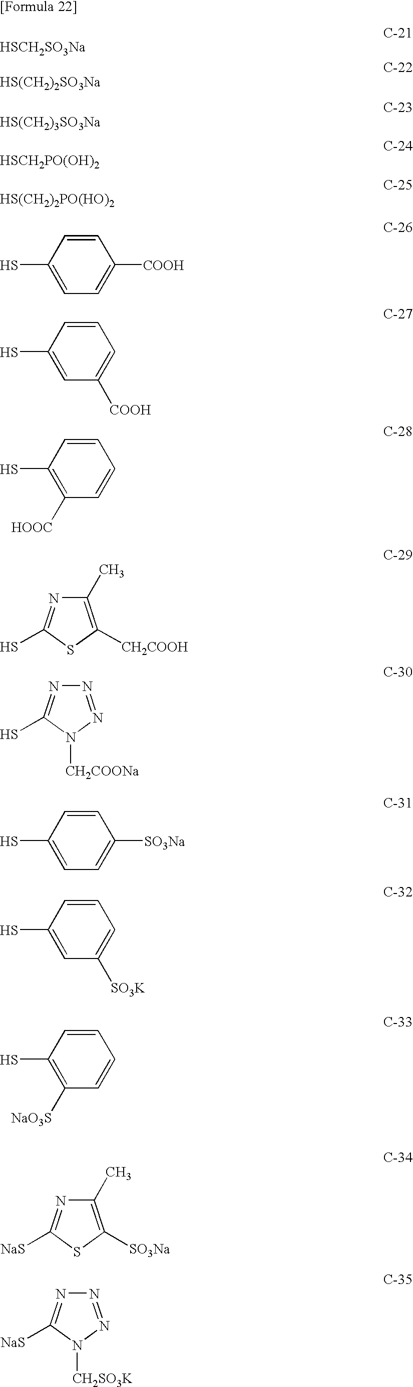

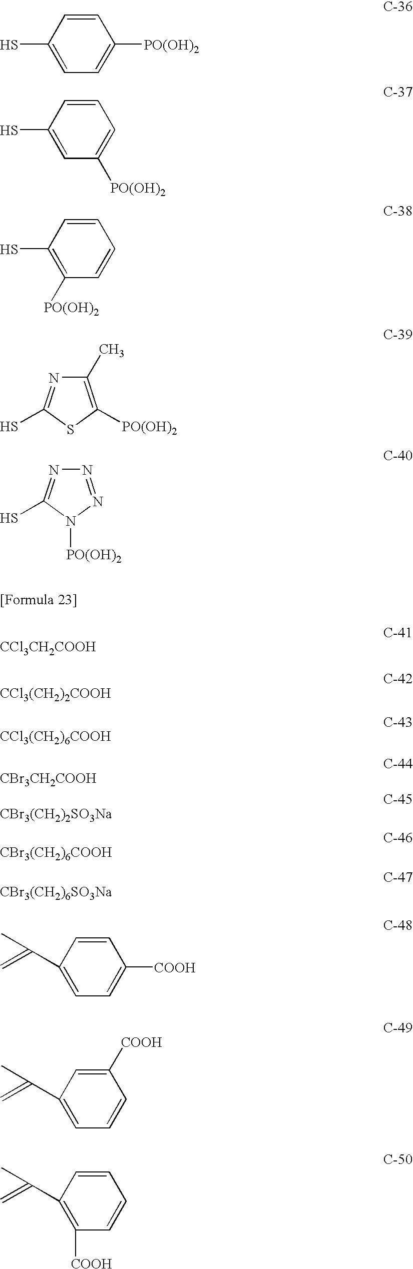

Hereinafter, among the materials required for constituting an optical compensation sheet according to the present invention, there are described in detail materials other than the fluoroaliphatic-group-containing polymer described above.

### <Flexible Strip Substrate>

A flexible strip substrate according to the present invention is preferably glass or a transparent polymer film.

The flexible strip substrate preferably has an optical transmittance of 80% or more. Examples of polymers constituting the polymer film may include cellulose esters such as cellulose acetate or cellulose diacetate, norbornene-based polymers and polymethyl methacrylate. Commercially available polymers (Arton and Zeonex, which are trade names of norbornene-based polymers) may also be used.

Among the examples, cellulose esters are preferred, and cellulose esters of lower fatty acids are more preferred. The term “lower fatty acids” means fatty acids having 6 or less carbon atoms. The number of carbon atoms is preferably 2 (cellulose acetate), 3 (cellulose propionate), or 4 (cellulose butyrate). Cellulose acetate is particularly preferred. Mixed fatty acid esters such as cellulose acetate propionate and cellulose acetate butyrate may also be used.

As described in WO 00/26705, known polymers readily causing birefringence such as polycarbonate and polysulfone may also be used for an optical compensation sheet according to the present invention when the molecules of the polymers are modified so that the occurrence of birefringence is controlled.

When an optical compensation sheet according to the present invention is used as a polarizing plate protective film or a phase contrast film, cellulose acetate having an acetic acid content of 55.0% to 62.5% is preferably used as a polymer film. The acetic acid content is more preferably in the range of 57.0% to 62.0%.

The term “acetic acid content” means the amount of combined acetic acid per one unit mass of cellulose. The acetic acid content is obtained by determining and calculating acetylation degree according to ASTM: D-817-91 (tests of cellulose acetate or the like).

The cellulose acetate preferably has a viscosity average polymerization degree (DP) of 250 or more, and more preferably 290 or more. Further, it is also preferred for the cellulose acetate to have a narrow molecular weight distribution of Mw/Mn (Mw represents mass average molecular weight; and Mn represents number average molecular weight) determined by gel permeation chromatography. Specifically, the value of Mw/Mn is preferably in the range of 1.0 to 1.7, more preferably in the range of 1.0 to 1.65, most preferably in the range of 1.0 to 1.6.

In cellulose acetate, hydroxyl groups at the 2-, 3- and 6-positions of cellulose are not equally substituted, and the substitution degree at the 6-position is apt to be relatively small. In a polymer film used in the present invention, however, the substitution degree at the 6-position of cellulose is preferably almost equal to or larger than those at the 2- and 3-positions.

The substitution degree at the 6-position is preferably 30% to 40%, more preferably 31% to 40%, and still more preferably 32% to 40%, based on the total substitution degree at the 2-, 3- and 6-positions. Further, the substitution degree at the 6-position is preferably 0.88 or more. The substitution degree at each position can be measured by NMR.

A cellulose acetate having a high substitution degree at its 6-position can be synthesized according to the methods of synthesis example 1 described in paragraphs number 0043 to 0044, synthesis example 2 described in paragraphs number 0048 to 0049, and synthesis example 3 described in paragraphs number 0051 to 0052 in Japanese Patent Application Laid-Open No. 11-5851.

### <Optically Anisotropic Layer>

The optically anisotropic layer is preferably designed so as to compensate the liquid crystal compound in the liquid crystal cell of a liquid crystal display device in a black state. The orientation state of the liquid crystal compound in the liquid crystal cell in a black state varies depending on the modes of the liquid crystal display device. The orientation state of the liquid crystal compound in the liquid crystal cell is described in IDW′00, FMC7-2, p. 411 to 414, and the like.

The optically anisotropic layer may be formed by forming a liquid crystal compound on a substrate directly or via an orientation film. The orientation film preferably has a thickness of 10 μm or less.

The optically anisotropic layer may be formed by coating a coating solution (composition for forming the optically anisotropic layer) comprising a liquid crystal compound, a fluoroaliphatic-group-containing polymer according to the present invention, and if necessary, a polymerization initiator and optional additives on the orientation film. Preferred examples of the orientation film are described in Japanese Patent Application Laid-Open No. 08-338913.

The liquid crystal compound used for forming the optically anisotropic layer includes a rod-like liquid crystal compound and a discotic liquid crystal compound. Each of the rod-like liquid crystal compound and the discotic liquid crystal compound may be a high-molecular-weight liquid crystal or a low-molecular-weight liquid crystal. The compounds may also include a compound in which a low-molecular-weight liquid crystal is crosslinked and does not exhibit liquid crystallinity.

Hereinafter, there are described components included in the composition for forming the optically anisotropic layer.

### (Rod-Like Liquid Crystal Compound)

Preferred examples of the rod-like liquid crystal compound may include azomethines, azoxys, cyanobiphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenyl cyclohexyl benzonitriles.

The examples of the rod-like liquid crystal compound also include metal complexes. It is also possible to use, as a rod-like liquid crystal compound according to the present invention, liquid crystal polymers comprising a rod-like liquid crystal compound in a repeating unit. In other words, the rod-like liquid crystal compound may be bonded to a (liquid crystal) polymer.

Examples of the rod-like liquid crystal compounds are described in the fourth, seventh and eleventh chapters of “Published Quarterly Chemical Review vol. 22 Chemistry of Liquid Crystals (Ekisho no Kagaku)” published in 1994 and edited by Japan Chemical Society; and in the third chapter of “Handbook of Liquid Crystal Devices (Ekisho Debaisu Handobukku)” edited by the 142th committee of Japan Society for the Promotion of Science.

The rod-like liquid crystal compounds desirably have a birefringence index in the range of 0.001 to 0.7.

The rod-like liquid crystal compounds desirably have a polymerizable group for fixing its orientation state. Preferred examples of the polymerizable group include unsaturated polymerizable groups and epoxy group, more preferably unsaturated polymerizable groups, and most preferably ethylenic unsaturated polymerizable groups.

### (Discotic Liquid Crystal Compound)

Examples of discotic liquid crystal compounds include benzene derivatives described in “Mol. Cryst.”, vol. 71, page 111 (1981), C. Destrade et al; truxane derivatives described in “Mol. Cryst.”, vol. 122, page 141 (1985), C. Destrade et al. and “Physics lett. A”, vol. 78, page 82 (1990); cyclohexane derivatives described in “Angew. Chem.”, vol. 96, page 70 (1984), B. Kohne et al.; and macrocycles based aza-crowns or phenyl acetylenes described in “J. C. S., Chem. Commun.”, page 1794 (1985), J. M. Lehn et al. and “J. Am. Chem. Soc.”, vol. 116, page 2, 655 (1994), J. Zhang et al.

Examples of the discotic liquid crystal compounds also include a compound having a discotic core at the molecular center and substituents, radiating from the core, such as linear alkyl or alkoxy groups or substituted benzoyloxy groups. It is preferred that molecules or molecular assembly have rotational symmetries to be oriented in a certain orientation state. The discotic liquid crystal compounds employed in preparing optically anisotropic layers are not required to maintain liquid crystallinity after contained in the optically anisotropic layers. For example, when a low-molecular-weight discotic liquid crystal compound having a reactive group to light and/or heat, is employed in preparation of an optically anisotropic layer, polymerization or cross-linking reaction of the compound is carried out upon exposure to heat and/or light. The polymerized or cross-linked compounds have thus high molecular weights and no longer exhibit liquid crystallinity. Preferred examples of the discotic liquid crystal compound are described in Japanese Patent Application Laid-Open No. 08-50206. The polymerization of discotic liquid crystal compounds is described in Japanese Patent Application Laid-Open No. 08-27284.

In order to fix the discotic liquid crystal compound by polymerization, a polymerizable group has to be bonded as a substituent to the disk-shaped core of the discotic liquid crystal compound. If the polymerizable group is bonded directly to the disk-shaped core, it is difficult to maintain an orientation state in polymerization reaction. Then a coupling group is incorporated between the disk-shaped core and the polymerizable group. Preferred examples of the discotic liquid crystal compound having a polymerizable group therefore include compounds represented by the following formula (5).

### General Formula (5)

### D(-LQ)r

In the formula (5), D is a disk-shaped core, L is a divalent liking group, Q is a polymerizable group, and r is an integer from 4 to 12.

Examples of the disk-shaped core (D) are shown below. In each of the examples, LQ or QL means the combination of a divalent coupling group (L) and a polymerizable group (Q).

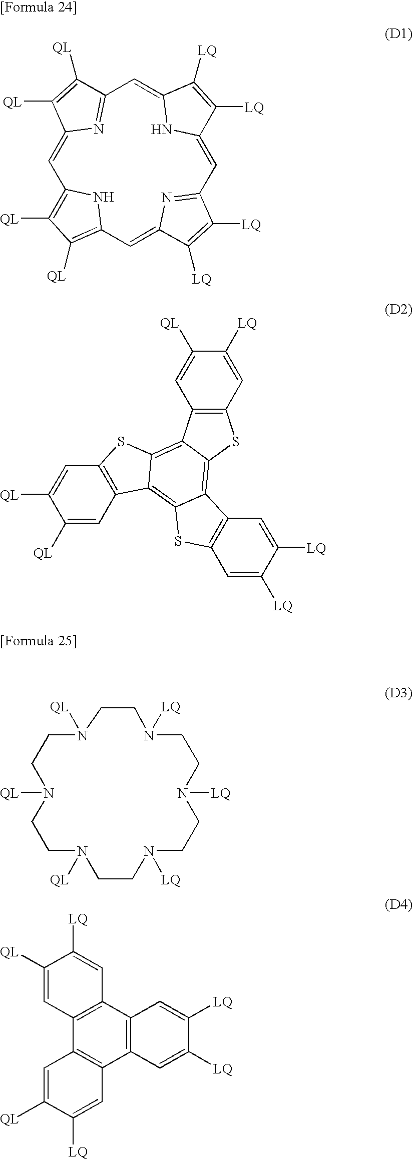

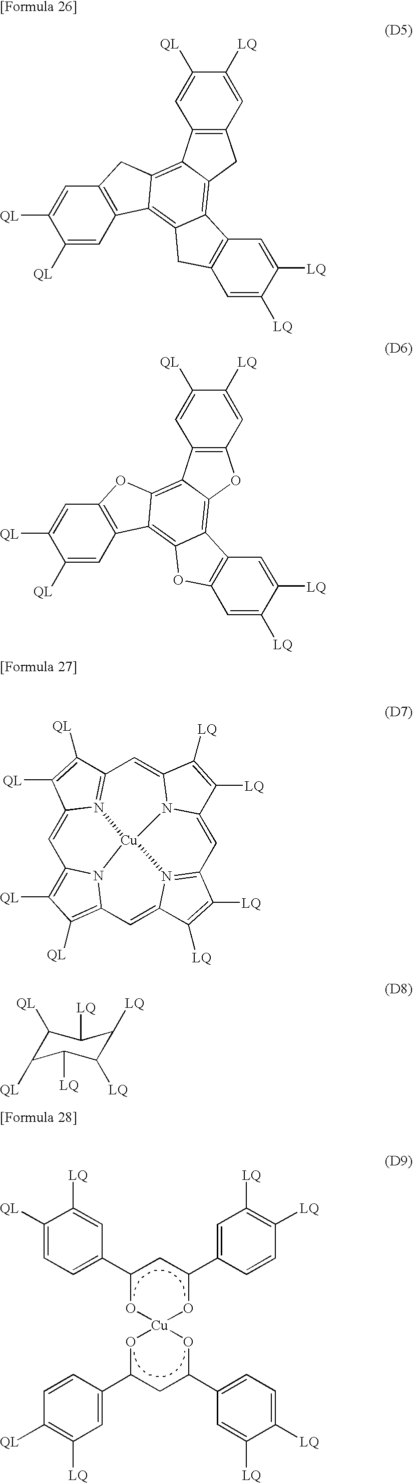

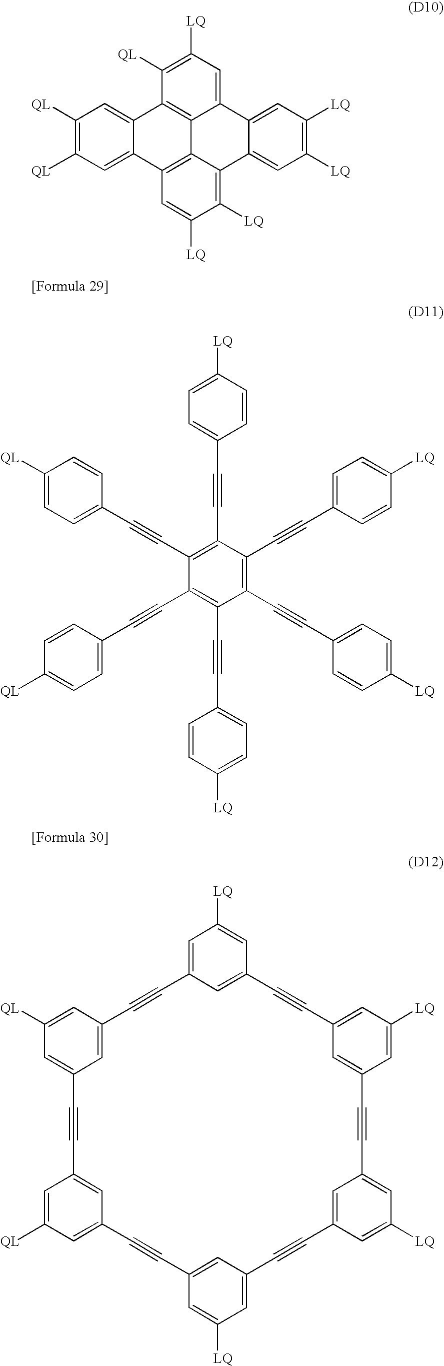

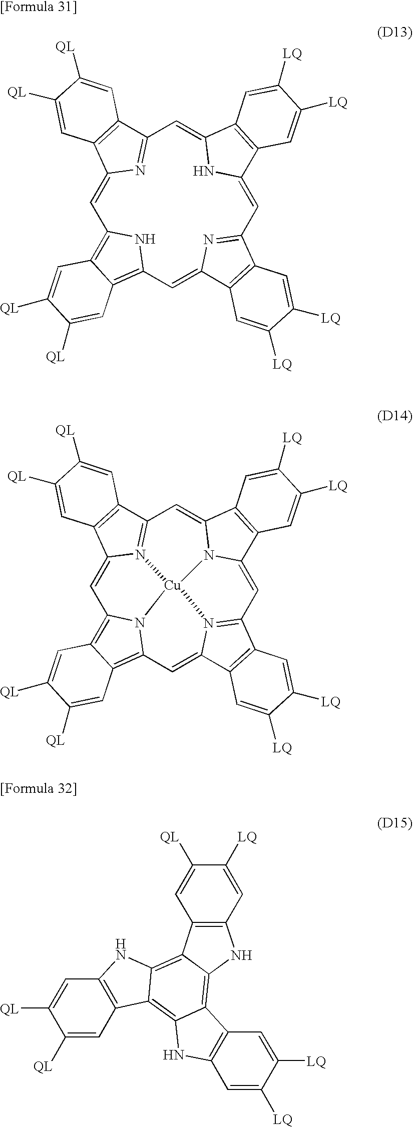

In the general formula (5), the divalent liking group (L) is preferably selected from the group consisting of alkylene groups, alkenylene groups, arylene groups, —CO—, —NH—, —O—, —S—, and combinations of the foregoing. The divalent liking group (L) is more preferably the combination of at least two divalent liking groups selected from the group consisting of alkylene groups, arylene groups, —CO—, —NH—, —O— and —S—. The divalent liking group (L) is still more preferably the combination of at least two divalent liking groups selected from the group consisting of alkylene groups, arylene groups, —CO—, and —O—. The number of carbon atoms of the alkylene groups is preferably 1 to 12. The number of the carbon atoms of the alkenylene groups is preferably 2 to 12. The number of the carbon atoms of the arylene groups is preferably 6 to 10.

Examples of the divalent coupling group (L) are listed below. The left end binds with the disk-shaped core (D), and the right end binds with the polymerizable group (Q). AL represents an alkylene group or an alkenylene group, and AR represents an arylene group. The alkylene group, alkenylene group and arylene group may have a substituent (e.g., alkyl group).

L1: -AL-CO—O-AL-, L2: -AL-CO—O-AL-O—, L3: -AL-CO—O-AL-O-AL-, L4: -AL-CO—O-AL-O—CO—, L5: —CO-AR—O-AL-, L6: —CO-AR—O-AL-O—, L7: —CO-AR—O-AL-O—CO—, L8: —CO—NH-AL-, L9: —NH-AL-O—, L10: —NH-AL-O—CO—,

L11: —O-AL-, L12: —O-AL-O—, L13: —O-AL-O—CO—, L14: —O-AL-O—CO—NH-AL-, L15: —O-AL-S-AL, L16: —O—CO-AL-AR—O-AL-O—CO—, L17: —O—CO-AR—O-AL-CO—, L18: —O—CO-AR-A-AL-C—CO—, L19: —O—CO-AR—O-AL-O-AL-O—CO—, L20: —O—CO-AR-O-AL-O-AL-O-AL-O—CO—, L21: —S-AL-, L22: —S-AL-O—, L23: —S-AL-O—CO—, L24: —S-AL-S-AL-, and L25: —S-AR-AL-.

The polymerizable group (Q) in the general formula (5) is determined depending on the types of polymerization reaction. Examples of the polymerizable group (Q) are shown below.

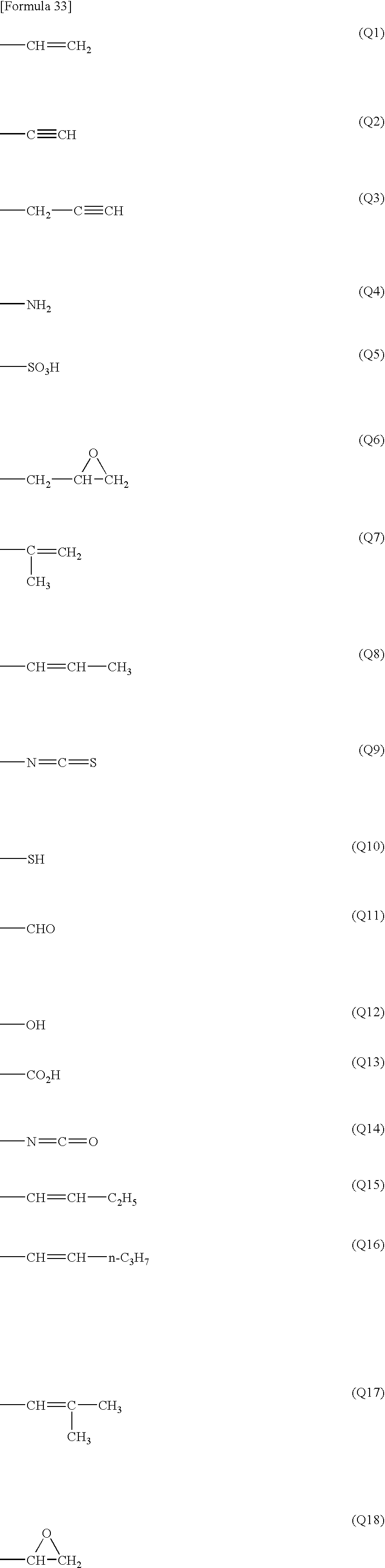

The polymerizable group (Q) is preferably selected from unsaturated polymerizable groups such as Q1, Q2, Q3, Q7, Q8, Q15, Q16 and Q17, and epoxy groups such as Q6 and Q18; more preferably selected from the unsaturated polymerizable groups; and still more preferably selected from the ethylenic unsaturated polymerizable group such as Q1, Q7, Q8, Q15, Q16 and Q17. The specific value of r is decided depending on the type of the disk-shaped core (D). The plural combinations of L and Q may be mutually different, but are preferably mutually the same combinations.

The mean direction of the longitudinal axes (disk faces) of a discotic liquid crystal compound (the mean of the directions of the longitudinal axes of molecules) may be generally adjusted by selecting a discotic liquid crystal compound or the material to be used in producing an orientation film, or by selecting rubbing treatment. The directions of the longitudinal axes (disk faces) of a discotic liquid crystal compound existing on the surface side (the air side) may be generally adjusted by selecting the type of a discotic liquid crystal compound or the types of additives to be used with the discotic liquid crystal compound.

Besides the abovementioned liquid crystal compound and fluoroaliphatic-group-containing polymer, the composition for forming an optically anisotropic layer may further contain an optional additive. Examples of the additive may include a cissing inhibitor; additives for controlling the tilt angle of an orientation film, that is, the tilt angle of a liquid crystal compound at the interface between its optically anisotropic layer and the orientation film; polymerization initiators; additives for decreasing orientation temperature, that is, plasticizers; polymerizable monomers; polymers; and surfactants.

### (Cissing Inhibitor)

In order to prevent cissing on coating, a cissing inhibitor may be used with a liquid crystal compound, particularly with a discotic liquid crystal compound. The cissing inhibitor is not restricted as long as the inhibitor is a polymer that does not excessively inhibit the change of the tilt angle or the orientation of the liquid crystal compound.

Examples of the polymer, which can be used as a cissing inhibitor, are disclosed in Japanese Patent Application Laid-Open No. 08-95030, and particularly preferred examples of the polymer may include cellulose esters. Examples of the cellulose esters may include cellulose acetate, cellulose acetate propionate, hydroxypropyl cellulose and cellulose acetate butyrate.

In order to prevent the cissing inhibitor from inhibiting the orientation of a liquid crystal compound, the preferred amount of a polymer usable as the cissing inhibitor to be added is typically from 0.1 to 10 percent by mass, more preferably from 0.1 to 8 percent by mass, and still more preferably from 0.1 to 5 percent by mass, based on the liquid crystal compound.

### (Agent for Controlling Tilt Angle on the Orientation Film Side)

As an additive for controlling the tilt angle of the surface on the orientation film side (agent for controlling the tilt angle on the orientation film side), a compound can be added that has both of a polar group and a non-polar group intramolecularly to the optically anisotropic layer.

Examples of the polar group may include R—OH, R—COOH, R—O—R, R—NH₂, R—NH—R, R—SH, R—S—R, R—CO—R, R—COO—R, R—CONH—R, R—CONHCO—R, R—SO₃H, R—SO₃—R, R—SO₂NH—R, R—SO₂NHSO₂—R, R—C═N—R, HO—P(—R)₂, (HO—)₂P—R, P(—R)₃, HO—PO(—R)₂, (HO—)₂PO—R, PO(—R)₃, R—NO₂ and R—CN. Organic salts such as ammonium salts, pyridinium salts, carboxylates, sulfonates or phosphates may be also used.

Among the polar groups, preferred are R—OH, R—COOH, R—O—R, R—NH₂, R—SO₃H, HO—PO(—R)₂, (HO—)₂PO—R, PO(—R)₃ and the organic salts. In the polar groups, R represents a non-polar group, and examples of the non-polar group are shown below.

Examples of the non-polar group may include: an alkyl group (preferably, a C₁₋₃₀ linear, branched or cyclic, substituted or unsubstituted alkyl group), an alkenyl group (preferably, a C₁₋₃₀ linear, branched or cyclic, substituted or unsubstituted alkenyl group), an alkynyl group (preferably, a C₁₋₃₀ linear, branched or cyclic substituted or unsubstituted alkynyl group), an aryl group (preferably, a C₆₋₃₀ substituted or unsubstituted aryl group), and a silyl group (preferably, a C₃₋₃₀ substituted or unsubstituted silyl group).

The non-polar group may further have a substituent such as a halogen atom, an alkyl group (which includes a cycloalkyl group and a bicyclo alkyl group), an alkenyl group (which includes a cycloalkenyl group and a bicyclo alkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (which includes an anilino group), an acylamino group, an aminocarbonylamino group, an alkoxycarbonylamino group, an aryloxycarbonylamino group, a sulfamoylamino group, an alkylsulfonylamino group, an arylsulfonylamino group, a mercapto group, an alkylthio group, an arylthio group, a heterocyclic thio group, a sulfamoyl group, a sulfo group, an alkylsulfinyl group, an arylsulfinyl group, an alkylsulfonyl group, an arylsulfonyl group, an acyl group, an aryloxycarbonyl group, an alkoxycarbonyl group, a carbamoyl group, an arylazo group, a heterocyclic azo group, an imido group, a phosphino group, a phosphinyl group, a phosphinyloxy group, a phosphinylamino group and a silyl group.

The agent for controlling the tilt angle of an orientation film may be added to a composition for forming an optically anisotropic layer. By orienting the molecules of a liquid crystal compound in the presence of the agent for controlling the tilt angle of an orientation film, the tilt angle of the liquid crystal molecules can be adjusted at the interface on the orientation film side. The variation of the tilt angle in this case is related to rubbing density. Compared to an orientation film having a high rubbing density, an orientation film having a low rubbing density allows the tilt angles of liquid crystal molecules to vary in a larger range when an identical amount of the agent for controlling the tilt angle of an orientation film is added. Accordingly, the preferred range of the amount of the agent for controlling the tilt angle of an orientation film may vary depending on conditions such as the rubbing density of an orientation film to be used or a desired tilt angle, but, typically, the amount of the agent is preferably from 0.00001 to 30 percent by mass, more preferably from 0.001 to 20 percent by mass and still more preferably from 0.005 to 10 percent by mass based on the mass of the liquid crystal compound. Note that the tilt angle is the angle between the longitudinal direction of the molecules of a liquid crystal compound and the normal line of an interface (orientation film interface or air interface).

Specific examples of the agent for controlling the tilt angle of an orientation film are shown below which agent is usable for the present invention, however, the present invention is not restricted to the following examples.

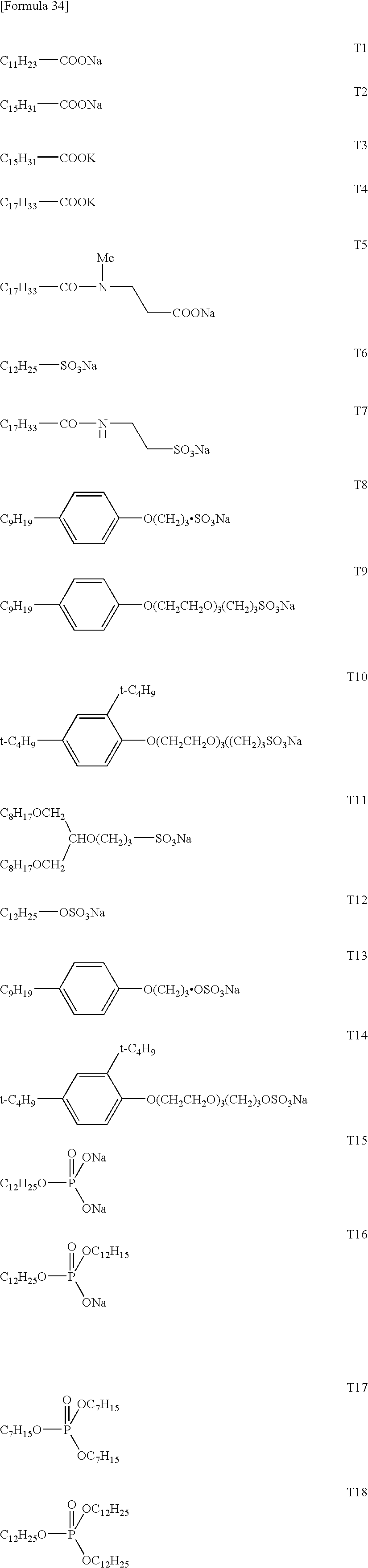

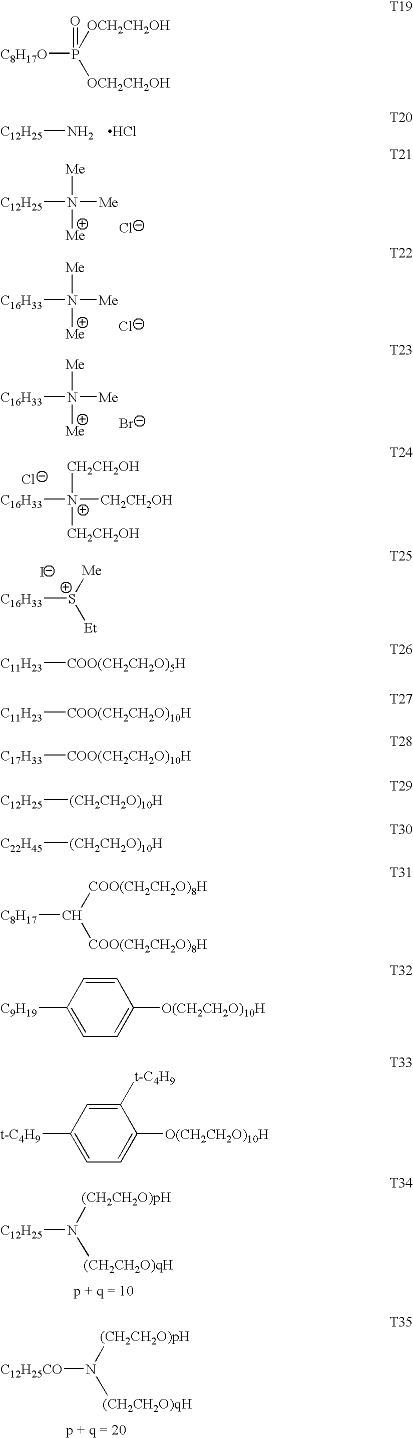

### (Polymerization Initiator)

It is preferred that the optically anisotropic layer is formed while the molecules of the liquid crystal compound are fixed in an orientation state. The orientation state is preferably fixed by using polymerization reaction. The polymerization reaction includes thermal polymerization reaction using a thermal polymerization initiator, and a photo polymerization reaction using a photo polymerization initiator. But, the photo polymerization reaction is preferred for preventing the substrate and the like from thermally deforming or altering.

Examples of the photo polymerization initiators include α-carbonyl compounds (described in U.S. Pat. Nos. 2,367,661, and 2,367,670), acyloin ethers (described in U.S. Pat. No. 2,448,828), α-hydrocarbon substituted aromatic acyloin compounds (described in U.S. Pat. No. 2,722,512), polycyclic quinone compounds (described in U.S. Pat. Nos. 3,046,127 and 2,951,758), combinations of triarylimidazole dimers and p-aminophenyl ketones (described in U.S. Pat. No. 3,549,367), acridine and phenazine compounds (described in Japanese Patent Application Laid-Open No. 60-105667 and U.S. Pat. No. 4,239,850) and oxadiazole compounds (described in U.S. Pat. No. 4,212,970).

The amount of the photo polymerization initiator to be used is preferably in the range of 0.01 to 20 percent by mass, and more preferably in the range of 0.5 to 5 percent by mass, based on the solid content of the coating solution. Light irradiation for polymerizing liquid crystal molecules is preferably conducted by using ultraviolet rays.

The irradiation energy is preferably in the range of 20 mJ/cm² to 50 J/cm², and more preferably in the range of 20 mJ/cm² to 5,000 mJ/cm², and still more preferably in the range of 100 mJ/cm² to 800 mJ/cm². The light irradiation can be conducted under heating condition to accelerate the photo polymerization reaction. A protective layer may be provided on the optically anisotropic layer.

### (Polymerizable Monomer)

The composition for forming an optically anisotropic layer may include a liquid crystal compound and further a polymerizable monomer. There is no particular restriction on the polymerizable monomer usable for the present invention as long as the monomer is compatible with the liquid crystal compound and neither excessively changes the tilt angle nor disturbs the orientation of the liquid crystal compound. Preferred monomers are compounds having a polymerizable ethylenic unsaturated group such as a vinyl group, a vinyloxy group, an acryloyl group, and a methacryloyl group. The amount of the polymerizable monomer to be added is generally in the range of 1 to 50 percent by mass, preferably in the range of 5 to 30 percent by mass, based on the liquid crystal compound. Particularly preferred is a monomer having two or more reactive functional groups to obtain the effect of enhancing the adhesion between the orientation film and the optically anisotropic layer.

### (Polymer)

The composition for forming an optically anisotropic layer contains a fluoroaliphatic-group-containing polymer according to the present invention, but the composition may further contain another polymer with a discotic liquid crystal compound. The polymer preferably has some compatibility with the discotic liquid crystal compound and has a property of changing the tilt angle of the discotic liquid crystal compound.

Examples of such a polymer may include cellulose esters. Preferred examples of the cellulose esters may include cellulose acetate, cellulose acetate propionate, hydroxy propyl cellulose and cellulose acetate butyrate.

In order to prevent the polymer from inhibiting the orientation of the discotic liquid crystal compound, the preferred amount of the polymer to be added is from 0.1 to 10 percent by mass, more preferably from 0.1 to 8 percent by mass, and still more preferably from 0.1 to 5 percent by mass, based on the discotic liquid crystal compound. It is preferred that the discotic liquid crystal compound has a transition temperature between the discotic nematic liquid crystal phase and the solid phase within a range of 70° C. to 300° C., more preferably 70° C. to 170° C.

### (Coating Solvent)

The composition for forming an optically anisotropic layer may be prepared as a coating solution. As a solvent for preparing the coating solution, an organic solvent is preferably used.

Examples of the organic solvent include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane), esters (e.g., methyl acetate, butyl acetate), ketones (e.g., acetone, methyl ethyl ketone) and ethers (e.g., tetrahydrofuran, 1,2-dimethoxyethane). Alkyl halides and ketones are preferred. Two or more organic solvents can be used in combination.

### (Coating Method)

A coating solution (a composition for forming an optically anisotropic layer) can be coated on the surface of an orientation film by known methods such as a wire-bar coating method, an extrusion coating method, a direct gravure coating method, a reverse gravure coating method or a die coating method. The content of a liquid crystal compound in the coating solution is preferably from 1 to 50 percent by mass, more preferably from 10 to 50 percent by mass, and still more preferably from 20 to 40 percent by mass.

The optically anisotropic layer preferably has a thickness of from 0.1 to 20 μm, more preferably from 0.5 to 15 μm, and still more preferably from 1 to 10 μm.

When a composition for forming an optically anisotropic layer is provided on an orientation film, liquid crystal molecules orient at the tilt angle of the orientation film at the interface between the optically anisotropic layer and the orientation film, whereas the molecules orient at the tilt angle of air interface at the interface between the optically anisotropic layer and air. By coating a composition for forming an optically anisotropic layer according to the present invention on the surface of an orientation film, and subsequently orienting the liquid crystal compound uniformly (mono-domain orientation), a hybrid orientation can be achieved where, described roughly but the following description is not an actual condition, the tilt angle of the liquid crystal compound (the angle between the normal line of the disk-shaped surface of the discotic liquid crystal compound and the normal line of the surface of a transparent substrate on which surface an orientation film is formed) varies continuously from the air interface to the orientation film interface, that is, to the direction of the depth of the optically anisotropic layer. An optical film with an optically anisotropic layer formed by orienting liquid crystal molecules in the hybrid orientation and fixing the molecules in the orientation state contributes to increasing the viewing angles of liquid crystal display devices, and preventing decrease of contrast, gradation reverse, black-and-white reverse, hue variation, and the like caused according to the change of the viewing angles.

In the presence of a fluoroaliphatic-group-containing polymer, liquid crystal molecules can be oriented at a tilt angle of air interface of 50° or more. In order to achieve the hybrid orientation that provides preferred properties as optical compensation sheets, the tilt angles of the liquid crystal molecules on the orientation film side are preferably from 3° to 30°. The tilt angles of the liquid crystal molecules on the orientation film side can be controlled by the methods mentioned above such as the rubbing density of the orientation film, or the agent for controlling the tilt angle of the orientation film.

On the other hand, the tilt angles of liquid crystal molecules on the air interface side can be adjusted by using the fluoroaliphatic-group-containing polymer and by selecting other compounds added if necessary such as a homogenous alignment agent composed of at least two compounds having the hydrogen linkable group. As mentioned above, a preferred hybrid orientation state can be achieved according to a display mode of a liquid crystal display device to which an optical film according to the present invention is applied.

In the present invention, it is preferred that the tilt angle of the orientation film is from 3° to 30°, and the tilt angle of on the air interface side is from 40° to 80°. When the tilt angle of the orientation film is too small, it takes more time for orienting a liquid crystal compound, particularly a discotic liquid crystal compound, in mono-domain orientation. In contrast, when the tilt angle of the orientation film is too large, optical properties preferred as optical compensation sheets cannot be obtained. Thus both of the cases are not preferable. In view of reducing time for achieving the mono-domain orientation and obtaining optical properties preferred as optical compensation sheets, the tilt angle of the orientation film is preferably from 5° to 30°, more preferably 10° to 30°, and still more preferably 20° to 30°. The tilt angle on the air interface side is preferably from 40° to 80°, more preferably 50° to 80°, and still more preferably 50° to 70°.

The tilt angle on the orientation film side can be controlled within several to several tens of degrees by the method of adding the agent for controlling the tilt angle of an orientation film, the method of changing the rubbing density of the orientation film, which method is described later in detail, or the like. As mentioned above, in the cases where an optically anisotropic layer is once formed and subsequently provided between two layers by transfer or the like, the interfaces of the optically anisotropic layer are not necessarily the orientation film interface and the air interface. In such an embodiment, it is preferred that the tilt angles of liquid crystal molecules on one interface side among the two interface sides of the optically anisotropic layer are in the range of the tilt angle on the orientation film side, and the tilt angles of liquid crystal molecules on the other interface side are in the range of the tilt angle of liquid crystal molecules on the air interface side.

### <Orientation Film>

An orientation film can be provided by methods such as subjecting an organic compound (preferably a polymer) to a rubbing treatment, obliquely depositing an inorganic compound, forming a layer having microgrooves, or accumulating an organic compound (e.g., ω-trichosanic acid, dioctadecylmethylammonium chloride, or methyl stearate) by Langmuir-Blodgett method (LB film). There are also known orientation films having an orientation function under an electric or magnetic field or irradiation.

In the present invention, there may be used any orientation film that can orient the liquid crystal compound of an optically anisotropic layer in a desired orientation which layer is provided on an orientation film. But, particularly preferred are orientation films formed by subjecting a polymer to a rubbing treatment in view of controllability of the tilt angle of the orientation film.

The rubbing treatment is typically performed by rubbing the surface of a polymer layer in a direction several times by using paper or cloth. In the present invention, the rubbing treatment is particularly preferably conducted according to the method described in “Handbook of Liquid Crystal (Ekisho Binran)” published by MARUZEN CO., Ltd. The thickness of the orientation film is preferably from 0.01 to 10 μm, and more preferably from 0.05 to 1 μm. Polymers that can be used for forming the orientation film are described in various documents, and various polymers are commercially available.

In preparing an orientation film for an optical film according to the present invention, polyvinyl alcohols and derivatives thereof are preferably used. In particular, modified polyvinyl alcohols to which hydrophobic groups are bonded are preferably used. Regarding the orientation films, it is possible to refer to the descriptions from the line 24 of p. 43 to the line 8 of p. 49 in WO01/88574A1.

It is possible to vary the rubbing density of an orientation film by a method described in “Handbook of Liquid Crystal (Ekisho Binran)” published by MARUZEN CO., Ltd. A rubbing density (L) is quantified by a formula (A) below.

L=N1{1+(2πrn/60v)} Formula (A)

In the formula (A), N is the number of rubbing, 1 is the contact length of a rubbing roller, r is a roller radius, n is revolutions per minute (rpm) of the roller, and v is a stage traveling rate (per second). The rubbing density is increased by increasing the number of rubbing, lengthening the contact length of the rubbing roller, increasing the radius of the roller, increasing the revolutions per minute of the roller and decreasing the stage traveling rate. On the other hand, the rubbing-density is decreased by doing the reverse of the foregoing. There is a relationship between the rubbing density and the tilt angle of an orientation film where increase of the rubbing density results in decrease of the tilt angle, and decrease of the rubbing density results in increase of the tilt angle.

It is noted that the orientation state of liquid crystal molecules can be kept without an orientation film by orienting the liquid crystal molecules and fixing the orientation state by polymerization or the like. It is thus also possible to prepare an optical film according to the present invention by forming the optically anisotropic layer on an orientation film, for example, an orientation film formed on a temporary substrate, and subsequently transferring only the optically anisotropic layer onto a transparent substrate. That is, the scope of the present invention includes embodiments of optical films not comprising orientation films.

### <Optical Compensation Sheet>

An optical compensation sheet according to the present invention comprises an optically anisotropic layer formed by fixing a liquid crystal compound in an orientation state. The liquid crystal compound is oriented in hybrid orientation where the angle between the director of molecules and the plane of the optically anisotropic layer varies along the depth direction of the layer. The liquid crystal compound is also oriented in twisted orientation where the direction of the axis obtained by projecting the director onto the optically anisotropic layer plane varies. The optically anisotropic layer contains the liquid crystal compound and a fluoroaliphatic-group-containing polymer.

In the optically anisotropic layer, the liquid crystal molecules are fixed in the state of hybrid orientation where the angle (hereinafter, also referred to as an inclination angle) between the director of the molecules and the plane of the layer varies in the direction of the thickness of the film, and also in an orientation state where the molecules are twisted at a twist angle φ in the direction of the thickness of the film.

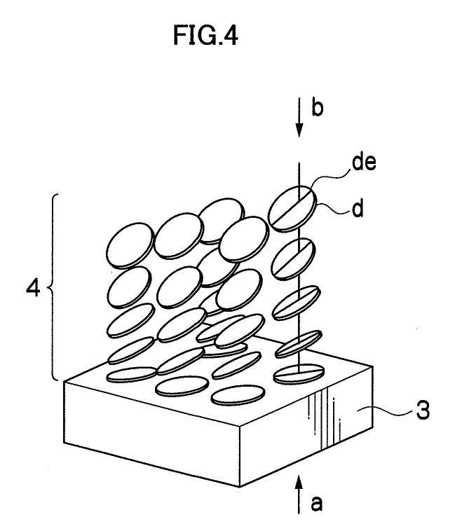

FIG. 4 is a schematic view of the orientation state of discotic liquid crystal molecules. When the liquid crystal molecules are discotic liquid crystal molecules, the director is parallel to the normal line direction of the disk-shaped surface of the molecule. When the liquid crystal molecules are rod-like liquid crystal molecules, the director is parallel to the longitudinal direction of the molecule.

As shown in FIG. 4, an optical compensation sheet according to the present invention is composed of a transparent substrate 3 and an optically anisotropic layer 4. In the optically anisotropic layer 4, the discotic liquid crystal molecules d are fixed in the orientation state where the molecules are twisted at a twist angle φ and in the hybrid orientation state where the inclination angle between the longitudinal axis de and the layer plane increases with local variations in the thickness direction of the layer from the transparent substrate interface to the air interface. In order to counterbalance the twisted structure and refractive index anisotropy of the liquid crystal layer of a liquid crystal cell, the twisted orientation of an optically anisotropic layer is preferably positioned to be opposite in direction to the twist of the liquid crystal layer when the liquid crystal cell is observed from the surface provided on the display side. For example, when an optical compensation sheet according to the present invention is provided between a polarizing film on the display side and a liquid crystal cell, and an optically anisotropic layer is provided on the liquid crystal cell side, the twisted orientation of the optically anisotropic layer is preferably fixed to be opposite in direction to the twisted orientation of the liquid crystal cell when the liquid crystal cell is observed from the direction a shown as an arrow from below upward in FIG. 4. In contrast, when an optical compensation sheet according to the present invention is provided between a polarizing film on the back side and a liquid crystal cell, and an optically anisotropic layer is provided on the liquid crystal cell side, the twisted orientation of the optically anisotropic layer is preferably fixed to be opposite in direction to the twisted orientation of the liquid crystal cell when the liquid crystal cell is observed from the direction b shown as an arrow from top downward in FIG. 4.

A preferred average inclination angle β and a preferred twist angle φ of the optically anisotropic layer are determined according to Rth of a transparent substrate, the thickness d of the optically anisotropic layer, and the like. When the optically anisotropic layer is used for optical compensation of a TN mode liquid crystal cell, the average inclination angle β is typically preferably from 30° to 60°, and more preferably from 35° to 55°.

In the optically anisotropic layer, discotic liquid crystal molecules are in the state of hybrid orientation, and thus the inclination angle of the disk-shaped surfaces of the molecules to the layer plane increases or decreases with variation according to the depth direction of the optically anisotropic layer and increase of the distance from the substrate interface. The inclination angle preferably increases as the distance increases. The inclination angle may vary in the manner of continuous increase, continuous decrease, intermittent increase, intermittent decrease, variations including continuous increase and continuous decrease, or intermittent variation including increase and decrease. The intermittent variation includes in the thickness direction a region where the inclination angle does not vary. In the present invention, the inclination angle variation may include the region where the inclination angle does not vary as long as the inclination angle increases or decreases on the whole. The inclination angle preferably varies continuously.

In the optically anisotropic layer, discotic liquid crystal molecules are in the state of twisted orientation, and thus the direction of the director is twisted at a twist angle φ from one interface to the other interface along the thickness direction of the optically anisotropic layer. The twist angle φ is preferably from 1° to 30°, more preferably from 2° to 25°, and still more preferably from 3° to 20°.

The twisted orientation in the optically anisotropic layer is preferably less than 1 pitch. The direction of the twisted orientation may be clockwise or counterclockwise, but the direction is preferably opposite to the twist direction of liquid crystal in a liquid crystal cell to be optically compensated.

### (Polarizing Film)

An optical compensation sheet according to the present invention remarkably exerts its function when attached to a polarizing plate or used as a protective film for protecting the polarizing film of a polarizing plate.

The polarizing film for use in the present invention is preferably a coating-type polarizing film represented by those produced by Optiva, or a polarizing film comprising a binder and iodine or a dichroic dye.

The iodine or dichroic dye in the polarizing film is oriented in the binder, thereby exerting its polarizing function. The iodine or dichroic dye is preferably oriented along the binder molecule or the dichroic dye is preferably oriented in one direction by undergoing self-organization like liquid crystal.

A general-purpose polarizer can be prepared, for example, by dipping a stretched polymer in a bath containing a solution of iodine or dichroic dye and allowing the iodine or dichroic dye to penetrate into the binder.

In the general-purpose polarizing film, iodine or dichroic dye is distributed in the region of about 4 μm from the polymer surface (about 8 μm in total of both sides) and for obtaining a satisfactory polarizing performance, a thickness of at least 10 μm is necessary. The degree of penetration can be controlled by the concentration of iodine or dichroic dye solution, the temperature of a bath containing the solution, and the dipping time in the solution.

As described above, the lower limit of the thickness of the binder is preferably 10 μm. The upper limit of the thickness is not particularly limited, however, in view of light leakage phenomenon caused when the polarizing plate is used for a liquid crystal display device, a thinner thickness is more preferred. The thickness is preferably smaller than that of the existing general-purpose polarizing plate (about 30 μm), that is, the thickness is preferably 25 μm or less, and more preferably 20 μm or less. When the thickness is 20 μm or less, the light leakage phenomenon is not observed in a 17-inch liquid crystal display device.

The binder of the polarizing film may be crosslinked. For the crosslinked binder, a self-crosslinkable polymer may be used. A polymer having a functional group or a binder obtained by introducing a functional group into a polymer is exposed to light or heat or subjected to pH change to effect a reaction between binders, whereby the polarizing film can be formed.

Also, a crosslinked structure may be introduced into the polymer by using a crosslinking agent. This structure can be formed by using a crosslinking agent, which is a compound having a high reactivity, and introducing a linking group derived from the crosslinking agent in between binders to crosslink the binders.

The crosslinking is generally performed by coating a coating solution containing a polymer or a mixture containing a polymer and a crosslinking agent on a transparent substrate and then heating the substrate. A treatment for crosslinking may be performed at any stage until a final polarizing plate is obtained because it is sufficient to obtain durability at the stage of final commercial product.

The binder of the polarizing film may be a self-crosslinkable polymer or a polymer which is crosslinked by using a crosslinking agent. Examples of the polymer include polymethyl methacrylate, polyacrylic acid, polymethacrylic acid, polystyrene, gelatin, polyvinyl alcohol, modified polyvinyl alcohol, poly(N-methylolacrylamide), polyvinyl-toluene, chlorosulfonated polyethylene, nitrocellulose, chlorinated polyolefin (e.g., polyvinyl chloride), polyester, polyimide, polyvinyl acetate, polyethylene, carboxymethyl cellulose, polypropylene, polycarbonate and copolymers thereof (e.g., acrylic acid/methacrylic acid copolymer, styrene/maleinimide copolymer, styrene/vinyl-toluene copolymer, vinyl acetate/vinyl chloride copolymer, ethylene/vinyl acetate copolymer). Among the examples, preferred are water-soluble polymers (e.g., poly(N-methylolacrylamide), carboxymethyl cellulose, gelatin, polyvinyl alcohol, modified polyvinyl alcohol), more preferred are gelatin, polyvinyl alcohol and modified polyvinyl alcohol, and most preferred are polyvinyl alcohol and modified polyvinyl alcohol.

The saponification degree of polyvinyl alcohol or modified polyvinyl alcohol is preferably from 70% to 100%, more preferably from 80% to 100%, and most preferably from 95% to 100%. The polymerization degree of polyvinyl alcohol is preferably from 100 to 5,000.

The modified polyvinyl alcohol is obtained by introducing a modifying group into a polyvinyl alcohol through copolymerization modification, chain transfer modification or block polymerization modification. In the copolymerization modification, —COONa, —Si(OH)₃, N(CH₃)₃.Cl, C₉H₁₉COO—, —SO₃Na or —C₁₂H₂₅ can be introduced as the modifying group. In the chain transfer modification, —COONa, —SH or —SC₁₂H₂₅ can be introduced as the modifying group. The polymerization degree of the modified polyvinyl alcohol is preferably from 100 to 3,000. The modified polyvinyl alcohol is described in Japanese Patent Application Laid-Open Nos. 08-338913, 09-152509 and 09-316127.

Particularly preferred are a non-modified polyvinyl alcohol and an alkylthio-modified polyvinyl alcohol each having a saponification degree of from 85% to 95%.

The polyvinyl alcohols and modified polyvinyl alcohols may be used in combination of two or more thereof

When the crosslinking agent for the binder is added in a large amount, the resistance against humidity and heat of the polarizing film can be enhanced. However, if the crosslinking agent is added in an amount of 50 or more percent by mass based on the binder, the orientation property of iodine or dichroic dye is deteriorated. The amount of the crosslinking agent to be added is preferably from 0.1 to 20 percent by mass, more preferably from 0.5 to 15 percent by mass, based on the binder.

Even after the completion of crosslinking reaction, the binder contains an unreacted crosslinking agent in some amount. The amount of the crosslinking agent remaining in the binder is preferably 1.0 or less percent by mass, more preferably 0.5 or less percent by mass. If the crosslinking agent is contained in the binder layer in an amount greater than 1.0 percent by mass, there may be caused a problem in the durability. That is, when a polarizing film having a large residual amount of a crosslinking agent is integrated into a liquid crystal display device and used for a long period of time or left standing in a high-temperature and high-humidity atmosphere for a long period of time, the degree of polarization may decrease. The crosslinking agent is described in U.S. Pat. No. RE23297. A boron compound (e.g., boric acid, borax) may also be used as the crosslinking agent.

As the dichroic dye, there may be used an azo-based dye, a stilbene-based dye, a pyrazolone-based dye, a triphenylmethane-based dye, a quinoline-based dye, an oxazine-based dye, a thiadine-based dye, or an anthraquinone-base dye. The dichroic dye is preferably water-soluble. Also, the dichroic dye preferably has a hydrophilic substituent (e.g., sulfo, amino, hydroxyl).

Examples of the dichroic dye include C.I. Direct Yellow 12, C.I. Direct Orange 39, C.I. Direct Orange 72, C.I. Direct Red 39, C.I. Direct Red 79, C.I. Direct Red 81, C.I. Direct Red 83, C.I. Direct Red 89, C.I. Direct Violet 48, C.I. Direct Blue 67, C.I. Direct Blue 90, C.I. Direct Green 59, and C.I. Acid Red 37. The dichroic dye is described in Japanese Patent Application Laid-Open Nos. 01-161202, 01-172906, 01-172907, 01-183602, 01-248105, 01-265205 and 07-261024. The dichroic dye is used in the form of a free acid, an alkali metal salt, an ammonium salt or an amine salt. By blending two or more dichroic dyes, polarizing films having various color hues can be produced. Preferred are a polarizing film using a compound (dye) that exhibits a black color when polarizing axes are crossed at right angle, and a polarizing film and polarizing plate where various dichroic molecules are blended to exhibit a black color because such polarizing films and a polarizing plate have excellent single plate transmittances and polarization ratios.

In order to increase the contrast ratio of a liquid crystal display device, the transmittance of the polarizing plate is preferably higher and the degree of polarization is also preferably higher. The transmittance of the polarizing plate is preferably from 30% to 50%, more preferably from 35% to 50%, and most preferably from 40% to 50% (the maximum single plate transmittance of the polarizing plate is 50%), with light having a wavelength of 550 nm. The degree of polarization is preferably from 90% to 100%, more preferably from 95% to 100%, and most preferably from 99% to 100%, with light having a wavelength of 550 nm.

The polarizing film and the optically anisotropic layer, or the polarizing film and the orientation film may be provided via an adhesive. Examples of the adhesive may include polyvinyl alcohol-based resins (including polyvinyl alcohols modified with an acetoacetyl group, a sulfonic acid group, a carboxyl group or an oxyalkylene group) and aqueous solutions of a boron compound. Among the examples, polyvinyl alcohol-based resins are preferred. The thickness of the adhesive layer after drying is preferably in the range of from 0.01 to 10 μm, particularly preferably in the range of from 0.05 to 5 μm.

### <Production of Polarizing Plate>

In view of yield of the polarizing film, the binder is preferably stretched (stretching method) at an inclination angle of 10° to 80° with respect to the longitudinal direction (MD direction) of the polarizing film or rubbed (rubbing method) and then dyed with iodine or dichroic dye. The binder is preferably stretched such that the inclination angle agrees with the angle between the transmission axis of two polarizing plates attached to both sides of a liquid crystal cell constituting LCD and the lengthwise or crosswise direction of the liquid crystal cell.

The inclination angle is generally 45°, however, in recently developed devices of transmission type, reflection type or transreflective type LCDs, the inclination angle is not necessarily 45°. It is thus preferred that the stretching direction can be desirably adjusted according to the design of LCD.

In the case of the stretching method, the stretching magnification is preferably from 2.5 to 30.0 times, more preferably from 3.0 to 10.0 times. The stretching may be performed by dry stretching in air or by wet stretching in the state of being dipped in water. The stretching magnification is preferably from 2.5 to 5.0 times in the dry stretching and from 3.0 to 10.0 times in the wet stretching. The stretching step may be performed separately over several times including oblique stretching. By performing the stretching separately over several times, more uniform stretching can be achieved even at high magnification stretching. Before the oblique stretching is conducted, crosswise or lengthwise stretching may be performed to some extent (to an extent of preventing the shrinkage in the width direction).

The stretching can be performed by biaxial stretching where the tenter stretching differs between left and right sides. The biaxial stretching is the same as the stretching method performed in normal film formation. In the biaxial stretching, the film is stretched at different rates in left and right sides and the thickness of a binder film before the stretching thus must be made different between left and right sides. In the cast film formation, the flow rate of a binder solution can be made different between left and right sides by tapering the die.

In this way, there is produced a binder film obliquely stretched at 100 to 800 with respect to the MD direction of a polarizing film.

In the case of the rubbing method, a rubbing treatment widely employed as a treatment for orienting liquid crystals of LCDs can be applied. That is, the surface of a film is rubbed in a constant direction by using paper, gauze, felt, rubber, nylon or polyester fiber, whereby orientation is imparted. In general, the film surface is rubbed several times by using cloth averagely flocked with fibers having uniform length and thickness. The rubbing treatment is preferably performed by using a rubbing roller where the circularity, cylindricity and deflection (eccentricity) of the roller itself all are 30 μm or less. The lap angle of a film to the rubbing roller is preferably from 0.1° to 90°. Note that a stable rubbing treatment can also be achieved by winding the film at 360° or more as described in Japanese Patent Application Laid-Open No. 08-160430.

In the case of rubbing a long film, the film is preferably conveyed by a transporting device at a rate of 1 to 100 m/min while applying a constant tension to the film. The rubbing roller is preferably freely rotatable in the horizontal direction with respect to the film traveling direction so as to set a rubbing angle desirably. An appropriate rubbing angle is preferably selected in the range of from 0° to 60°. When the film is used for a liquid crystal display device, the rubbing angle is preferably from 40° to 50°, particularly preferably 45°.

On the surface of the polarizing film opposite to the optically anisotropic layer, a polymer film is preferably disposed (to constitute a configuration of optically anisotropic layer/polarizing film/polymer film).

Hereinafter, there are described various definitions in the present specification.

In the present specification, each of the terms “45°”, “parallel”, and “orthogonal” includes the range of precise angle ± an angle less than 5°. The deviation from the precise angle is preferably less than 4°, and more preferably less than 3°. As for the angle, “+” means a counterclockwise direction, and “−” means a clockwise direction.

In the present specification, the term “lag phase axis” means the direction at which refractive index becomes the largest. The term “visible light range” means the range of from 380 to 780 nm. The refractive index is measured at a measurement wavelength of λ=550 nm in the visible light range unless otherwise stated.

In the present specification, the term “orientation controlling direction of the liquid crystal compound of an optically anisotropic layer” means the direction at which a treatment is conducted to an orientation film or a substrate for the purpose of orienting the liquid crystal compound to a predetermined direction at the interface between the orientation film and the optically anisotropic layer, for example, the direction at which a rubbing treatment is conducted to an orientation film.

In the present specification, the term “polarizing plate” includes both a long polarizing plate and a polarizing plate cut into a size that can be installed in a liquid crystal device unless otherwise stated. In the present specification, the term “cut” includes stamping, cutting out, and the like. In the present specification, the terms “polarizing film” and “polarizing plate” are used distinctive from each other. The “polarizing plate” is defined as a stack having a transparent protective film at least on one surface of the “polarizing film” for the purpose of protecting the “polarizing film”.

In the present specification, the in-plane retardation (Re) and the thickness-direction retardation (Rth) of a film are defined respectively by the following equations (I) and (II).

Re=(nx−ny)×d Equation (I):

Rth={(nx+ny)/2−nz}×d Equation (II):

In the equations (I) and (II), nx represents the in-plane refractive index of the film in the direction of lag phase axis at which refractive index becomes the largest. In the equations (I) and (II), ny represents the in-plane refractive index of the film in the direction of advance phase axis at which refractive index becomes the smallest. In the equation (II), nz represents the refractive index of the film in the direction of the thickness of the film. In the equations (I) and (II), d represents the thickness of the film in nm.

Re is measured by letting in light in the direction of the normal to the film in a KOBRA 21ADH (produced by Oji Scientific Instruments). Rth is calculated by using the KOBRA 21ADH on the basis of retardation values measured in the total three directions: Re obtained above, a retardation value measured by letting in light from the direction inclined at an angle of +40° from the direction of the normal to the film with using the in-plane lag phase axis (judged by the KOBRA 21ADH) as an inclined axis (rotary axis), and a retardation value measured by letting in light from the direction inclined at an angle of −40° from the direction of the normal to the film with using the in-plane lag phase axis as an inclined axis (rotary axis). As for hypothetical average refractive index, there may be used values disclosed in “Polymer Handbook”, JOHN WILEY & SONS, INC. and various catalogues of optical films. Films with unknown average refractive indexes, an Abbe refractometer may be used to measure the indexes. The average refractive indexes of major optical films are shown below: cellulose acylate (1.48), cycloolefin polymer (1.52), polycarbonate (1.59), polymethyl methacrylate (1.49), polystyrene (1.59). By inputting the hypothetical average refractive index value and the film thickness, the KOBRA 21ADH calculates nx, ny, and nz.

A preferred substrate according to the present invention has a positive Rth and negative birefringence.

In the present invention, the optical properties of an optically anisotropic layer containing a liquid crystal compound are calculated by the following manner. The inclination angle of the liquid crystal compound in the vicinity of the orientation film, the inclination angle of the liquid crystal compound at the air interface, and the average inclination angle in the optically anisotropic layer are determined by measuring retardations from multiple observation directions using an ellipsometer (M-150 manufactured by JASCO Corporation), assuming a refractive index ellipsoid model from the measured retardations, and calculating the angles according to a procedure described in Designing Concepts of the Discotic Negative Birefringence Compensation Films SID98 DIGEST.

Hereinafter, there are described preferred embodiments of an optically anisotropic layer in each liquid crystal mode in a liquid crystal display device.

### (TN-Mode Liquid Crystal Display Device)

A TN mode liquid crystal cell is most frequently used as a color TFT liquid crystal display device and the liquid crystal cell is described in many documents.

The TN mode liquid crystal cell in black display has an orientation state such that rod-like liquid crystal molecules are rising up in the center part of the cell and lying down in the vicinity of a substrate in the cell.

The rod-like liquid crystal compound in the center part of the cell can be compensated by using a discotic liquid crystal compound in homeotropic orientation (horizontal orientation such that disk-shaped surfaces are lying down) or a (transparent) substrate. The rod-like liquid crystal compound in the vicinity of a substrate in the cell can be compensated by using a discotic liquid crystal compound in hybrid orientation (orientation such that the tilt of longitudinal axis varies along the distance from the polarizing film).

Alternatively, the rod-like liquid crystal compound in the center part of the cell can be compensated by using a rod-like liquid crystal compound in homogeneous orientation (horizontal orientation such that longitudinal axes are lying down) or a (transparent) substrate. The rod-like liquid crystal compound in the vicinity of the substrate in the cell can be compensated by the discotic liquid crystal compound in hybrid orientation.

The liquid crystal compound in homeotropic orientation is oriented by making an angle of 85° to 95° between the average orientation direction of longitudinal axes of the liquid crystal compound and the plane of a polarizing film.

The liquid crystal compound in homogeneous orientation is oriented by making an angle of less than 5° between the average orientation direction of longitudinal axes of the liquid crystal compound and the plane of a polarizing film.

The liquid crystal compound in hybrid orientation is preferably oriented by making an angle of 15° or more, more preferably from 15° to 85°, between the average orientation direction of longitudinal axes of the liquid crystal compound and the plane of a polarizing film.

Each of an optically anisotropic layer where a (transparent) substrate or a discotic liquid crystal compound is oriented in homeotropic orientation, an optically anisotropic layer where a rod-like liquid crystal compound is oriented in homogeneous orientation, and an optically anisotropic layer comprising a mixture of a discotic liquid crystal compound in homeotropic orientation and a rod-like liquid crystal compound in homogeneous orientation preferably have an Rth retardation value of 40 to 200 nm and an Re retardation value of 0 to 70 nm.

The discotic liquid crystal compound layer in homeotropic orientation (horizontal orientation) and the rod-like liquid crystal compound layer in homogeneous orientation (horizontal orientation) are described in Japanese Patent Application Laid-Open Nos. 12-304931 and 12-304932, and the discotic liquid crystal compound layer in hybrid orientation is described in Japanese Patent Application Laid-Open No. 08-50206.

### (OCB-Mode Liquid Crystal Display Device)

An OCB mode liquid crystal cell is a liquid crystal cell in a bend orientation mode where a rod-like liquid crystal compound is oriented substantially in the reverse direction (symmetrically) between the upper part and the lower part of the liquid crystal cell. A liquid crystal display device using a liquid crystal cell in the bend orientation mode is disclosed in U.S. Pat. Nos. 4,583,825 and 5,410,422. The rod-like liquid crystal compound is oriented symmetrically between the upper part and the lower part of the liquid crystal cell, the liquid crystal cell in the bend orientation mode thus has a self-optical compensating function. Therefore, the liquid crystal mode is called an optically compensatory bend (OCB) liquid crystal mode.

Similarly to the TN-mode liquid crystal cell, the OCB-mode liquid crystal cell in black display also has an orientation state such that rod-like liquid crystal compound is rising up in the center part of the cell and lying down in the vicinity of a substrate in the cell.

The orientation state of the liquid crystal cell in black display is the same as that of the TN-mode liquid crystal cell, and a preferred embodiment is thus the same as that of the TN mode. However, the OCB mode has a larger range where the liquid crystal compound is rising up in the center part of the cell than the TN mode. Thus retardation value is required to be slightly adjusted in the optically anisotropic layer where a discotic liquid crystal compound is oriented in homeotropic orientation, or the optically anisotropic layer where a rod-like liquid crystal compound is oriented in homogeneous orientation. Specifically, each of the optically anisotropic layer where a discotic liquid crystal compound on a (transparent) substrate is oriented in homeotropic orientation, and the optically anisotropic layer where a rod-like liquid crystal compound is oriented in homogeneous orientation preferably has an Rth retardation value of 150 to 500 nm and an Re retardation value of 20 to 70 nm.

### (VA-Mode Liquid Crystal Display Device)

In a VA-mode liquid crystal cell, a rod-like liquid crystal compound is vertically oriented in substance when voltage is not applied.

The VA-mode liquid crystal cell includes (1) a strict VA-mode liquid crystal cell where a rod-like liquid crystal compound is vertically oriented in substance when voltage is not applied, and the compound is horizontally oriented in substance when voltage is applied (described in Japanese Patent Application Laid-Open No. 02-176625), (2) a (MVA-mode) liquid crystal cell formed to have multi-domain VA mode so as to enlarge viewing angle (described in SID97, Digest of tech. Papers (preliminaries), 28, 845 (1997)), (3) a liquid crystal cell of a mode (n-ASM mode) where a rod-like liquid crystal compound is vertically oriented in substance when voltage is not applied, and the compound is oriented in twisted multi-domain orientation when voltage is applied (described in Proceedings of Liquid Crystal Forum of Japan, 58-59 (1998)), and (4) a liquid crystal cell of SURVAIVAL mode (published in LCD international 98).

In black display of a VA-mode liquid crystal display device, the rod-like liquid crystal compound in the liquid crystal cell is mostly rising up, and it is thus preferred that the liquid crystal compound is compensated by using an optically anisotropic layer where a discotic liquid crystal compound is oriented in homeotropic orientation, or an optically anisotropic layer where a rod-like liquid crystal compound is oriented in homogeneous orientation, and separately, the viewing angle dependency of a polarizing plate is compensated by using an optically anisotropic layer where a rod-like liquid crystal compound is oriented in homogeneous orientation and the angle between the average orientation direction of longitudinal axes of the rod-like liquid crystal compound and the transmission axis direction of a polarizing film is less than 5°.

Each of the optically anisotropic layer where a (transparent) substrate or a discotic liquid crystal compound is oriented in homeotropic orientation, and the optically anisotropic layer where a rod-like liquid crystal compound is oriented in homogeneous orientation preferably has an Rth retardation value of 150 to 500 nm and an Re retardation value of 20 to 70 nm.

### (Other Liquid Crystal Display Devices)

In ECB-mode and STN-mode liquid crystal display devices, optical compensation can be performed in the same manner of thinking as above.

### EXAMPLES

The present invention is described in further detail based on examples, however, the present invention is not limited thereto.

### (Specifications of Fluoro Aliphatic-Group-Containing Polymers)

1) ωF(C4+C6) type polymers P-3 and P-4 (copolymer including a monomer having the end structure of —(CF₂CF₂)₂F and a monomer having the end structure of —(CF₂CF₂)₃F)

### [Formula 37]

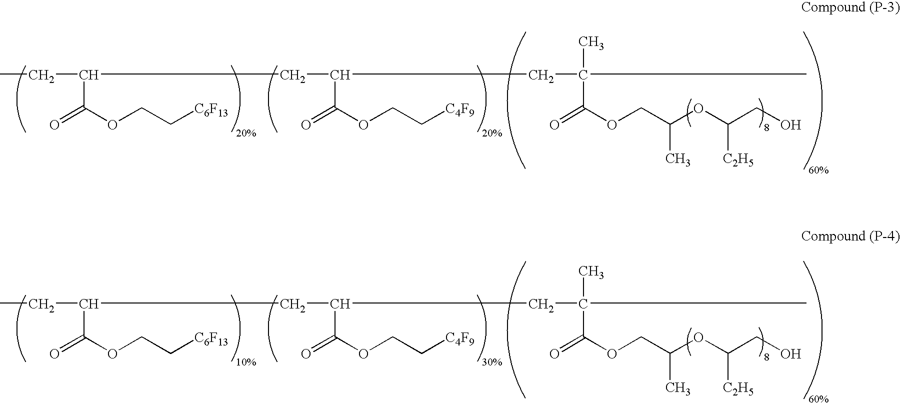 [0265] 2) acidic-group-containing fluorine polymer P-0

### [Formula 38]

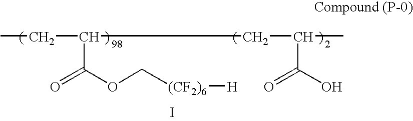 [0267] 3) ω-H type polymer P-1 (polymer including a monomer having the end structure of —(CF₂CF₂)₃H)

### [Formula 39]

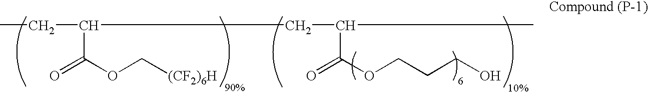 [0269] 4) ωFC6 type polymer P-2 (polymer including a monomer having the end structure of —(CF₂CF₂)₃F)

### [Formula 40]

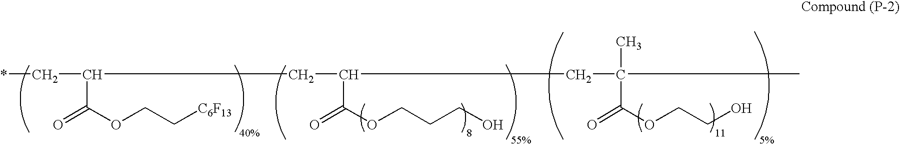 [0271] 5) ωFC4 type polymer P-8 (polymer including a monomer having the end structure of —(CF₂CF₂)₂F)

### [Formula 41]

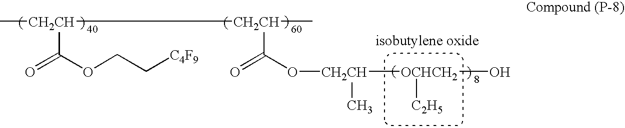

### Example 1

First, there were evaluated the streak, unevenness, and orientation property of a liquid crystal cell formed by using a composition for forming an optically anisotropic layer to which composition a fluoroaliphatic-group-containing polymer was added. There were also evaluated similarly cases where the type and/or the added amount of the fluoroaliphatic-group-containing polymer were changed.

### Example 1

### <Preparation of Polymer Substrate>

The following compositions were charged in a mixing tank and stirred while heating at 30° C., thereby dissolving the respective components to prepare a cellulose acetate solution.

| Composition of cellulose acetate solution | Internal | External |
|---|---|---|
| (parts by mass) | layer | layer |
| Cellulose acetate having a degree of acetylation of | 100 | 100 |
| 60.9% | | |
| Triphenyl phosphate (plasticizer) | 7.8 | 7.8 |
| Biphenyl diphenyl phosphate (plasticizer) | 3.9 | 3.9 |
| Methylene chloride (first solvent) | 293 | 314 |
| Methanol (second solvent) | 71 | 76 |
| 1-Butanol (third solvent) | 1.5 | 1.6 |
| Silica fine particle (AEROSIL R972, manufactured by | 0 | 0.8 |
| Nippon Aerosil Co., Ltd) | | |
| Retardation increasing agent as described below | 1.7 | 0 |

| | |
|---|---|
| | [Formula 42] |
| 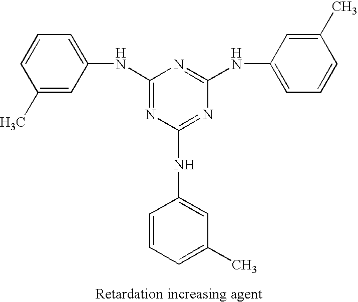 | |

The resulting dope for the internal layer and dope for the external layer were cast on a drum cooled at 0° C. by using a three-layer co-casting die. A film having an amount of the residual solvent of 70 percent by mass was stripped off from the drum and dried at 80° C. while the both ends of the film were fixed by using a pin tenter and the film was delivered in a drawing ratio of 110% in the delivery direction. When the amount of the residual solvent reached 10%, the film was dried at 110° C. After that, the resulting film was dried at a temperature of 140° C. for 30 minutes to prepare a cellulose acetate film having an amount of the residual solvent of 0.3 percent by mass (external layer: 3 μm, internal layer: 74 μm, external layer: 3 μm). Thus prepared cellulose acetate film (CF-02) was processed into a polymer substrate (PK-1), and the optical properties of the PK-1 were measured.

The polymer substrate (PK-1) had a width of 1,340 mm and a thickness of 80 μm. A retardation value (Re) at a wavelength of 500 nm was measured by using an ellipsometer (M-150 manufactured by JASCO Corporation), and the value was 6 nm. Also, a retardation value (Rth) at a wavelength of 500 nm was measured, and the value was 90 nm.

The polymer substrate (PK-1) was immersed in a 2.0 N potassium hydroxide solution (at 25° C.) for 2 minutes, subsequently neutralized with sulfuric acid, washed with pure water, and dried. Surface energy of the polymer substrate (PK-1) was determined by a contact angle method, and the energy was 63 mN/m.

### <Preparation of Orientation Film for Optically Anisotropic Layer>

A coating solution having the following composition was coated in an amount of 28 mL/m² on a surface of the polymer substrate (PK-1) by using a #16 wire bar coater. The coated solution was dried by using warm air at 60° C. for 60 seconds and further by using warm air at 90° C. for 150 seconds.

### (Composition of Coating Solution for Orientation Film)

Modified polyvinyl alcohol described below: 20 parts by mass
Water: 360 parts by mass
Methanol: 120 parts by mass
Glutaraldehyde (crosslinking agent): 1 part by mass

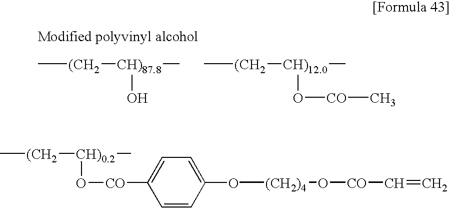

### <Formation of Optically Anisotropic Layer>

An optically anisotropic layer was prepared by existing process for producing optical compensation sheets to which a drying device was incorporated. In basic production processes for optical compensation sheets, web 12 is delivered by a delivery device to a rubbing treatment roll and a coating process by slot die coating, and immediately after the process, the web 12 is subjected to a drying process according to the present invention. After that, the web 12 passes through a drying zone, a heating zone, and exposure by an ultraviolet lamp and the web 12 is wound by using a winding machine. A decompression chamber was provided on the opposite side to the traveling direction of the web 12 without contacting the web 12 so that decompression can be sufficiently adjusted in bead.

An upstream lip land length (IUP) was set to be 1 mm, and a downstream lip land length (ILO) was set to be 50 μm. By using a slot die 16, the coating solution was coated on the web 12 in a coating amount according to each condition shown in Table 1. The coating rate was 50 m/min.

As for the web 12, there was used the polymer substrate (PK-1) to which an orientation film was coated. The gap length between the web 12 and the downstream lip land was set to be 40 μm. The orientation film was subjected to rubbing treatment in the direction parallel to the lag phase axis (measured at a wavelength of 632.8 nm) of the polymer substrate (PK-1). In the rubbing treatment, the rotational peripheral velocity of a rubbing roller was set to be 5.0 m/second, and pressure of the rubbing roller against the resin layer of the orientation film was set to be 9.8×10⁻³ Pa.

As the coating solution, there was used the following composition for an optically anisotropic layer. Immediately after the solution was coated, the solution was subjected to initial drying by using the dryer 18 shown in FIG. 1. The entire length of the dryer 18 was 5 m. The condensation plate 30 was provided at a predetermined inclination angle so that the downstream side, in the traveling direction, of the plate was apart from the coated film. The drying rates in using the dryer 18 were set according to the conditions shown in Table 1.

The web 12 subjected to the initial drying by using the dryer 18 was passed through the heating zone set at 130° C. The surface of the liquid crystal layer of the web 12 was irradiated with ultraviolet rays from an ultraviolet lamp of 120 W/cm in an atmosphere at 60° C. Thus an optical compensation sheet (KH-1) was prepared.

### (Composition of Coating Solution for Optically Anisotropic Layer)

The following compositions were dissolved in 102 parts by mass of methyl ethyl ketone to prepare a coating solution.

Discotic liquid crystal compound (1) described below: 41.01 parts by mass

Ethylene oxide-modified trimethylolpropane triacrylate (V#360, manufactured by Osaka Organic Chemical Industry Ltd.): 4.06 parts by mass

Cellulose acetate butyrate (CAB551-0.2 manufactured by Eastman Chemical Company): 0.34 parts by mass

Cellulose acetate butyrate (CAB531-1 manufactured by Eastman Chemical Company): 0.11 parts by mass

Fluoroaliphatic-group-containing polymers that satisfy the conditions of Table 1 and 3 among the 1) to 5) polymers: 0.11 parts by mass

Photopolymerization initiator (IRGACURE 907 manufactured by Ciba-Geigy AG): 1.35 parts by mass

Sensitizer (KAYACURE DETX, manufactured by Nippon Kayaku Co., Ltd.: 0.45 parts by mass

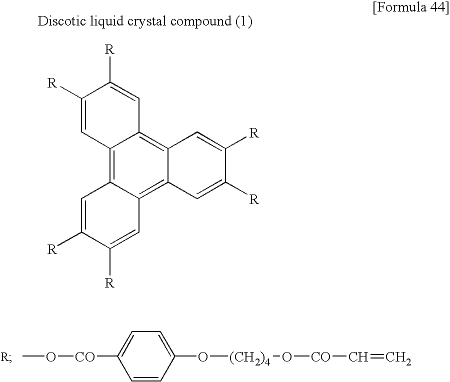

Thus prepared optical compensation sheet had an Re retardation value of 50 nm measured at a wavelength of 546 nm. The polarizing plate was positioned in cross-Nicol configuration, and the resulting optical compensation sheet was observed with respect to the presence of unevenness. As a result, no unevenness was observed even by viewing the sheet in the front direction and in the oblique direction inclined by 60° from the normal direction.

### (Evaluation of Inclination Angle in the Vicinity of Air Interface of Liquid Crystal Compound (Evaluation of Optical Property))

The inclination angle in the vicinity of the air interface of a liquid crystal compound in an optically anisotropic layer was determined by measuring the retardations from various observation angles by using an ellipsometer (APE-100 manufactured by SHIMADZU CORPORATION), and by calculating the angles according to the method described in Jpn. J. Appl. Phys. Vol. 36 (1997) pp. 143 to 147. The measurement wavelength was 632.8 nm. The tendency of obtaining larger inclination angle was evaluated as an optical property according to the following standards (When the layer has larger tendency of providing larger inclination angle, the layer has more excellent optical property.)

A: excellent, B: good, C: fair, D: poor

### <Preparation of Polarizer (Polarizing Film)>

PVA having an average degree of polymerization of 4,000 and a saponification degree of 99.8 mol % was dissolved in water to obtain a 4.0% aqueous solution. The solution was band cast by using a tapered die and dried to form a film having a width of 110 mm and a thickness of 120 μm on the left end and 135 μm on the right end before being stretched.

The film was stripped off from the band, and obliquely stretched to the direction at 45° in dried state, immersed in an aqueous solution of 0.5 g/L of iodine and 50 g/L of potassium iodide at 30° C. for 1 minute, subsequently immersed in an aqueous solution of 100 g/L of boric acid and 60 g/L of potassium iodide at 70° C. for 5 minutes, rinsed with water in a rinsing bath at 20° C. for 10 seconds, and dried at 80° C. for 5 minutes to obtain an iodine-based polarizer (HF-1). The polarizer had a width of 660 mm and a thickness of 20 μm both on the left and right ends.

### <Preparation of Polarizing Plate>

Onto one surface of the polarizer (HF-1), the prepared optical compensation sheet was attached by using a polyvinyl alcohol-based adhesive. An 80 μm-thick triacetyl cellulose film (TD-80U, produced by Fuji Photo Film Co., Ltd.) was saponified and attached to the opposite side of the polarizer (HF-1) by using a polyvinyl alcohol-based adhesive.

The transmission axis of the polarizer (HF-1) and the lag phase axis of the polymer substrate (PK-1) were positioned to intersect at right angles. A polarizing plate (HB-1) was thus prepared.

### <Preparation of TN Liquid Crystal Cell>

A pair of polarizing plates provided in a liquid crystal display device (AQUOS LC20C1S, manufactured by Sharp Corporation) using a TN-mode liquid crystal cell was stripped off and instead, one sheet of the polarizing plate (HB-1) prepared above was attached to each of the observer side and the backlight side of the device via an adhesive such that the optical compensation sheet (KH-1) was on the liquid crystal cell side. The polarizing plates were positioned so that the transmission axis of the polarizing plate on the observer side and the transmission axis of the polarizing plate on the backlight side formed an O-mode.

### <Evaluation of Streaks>

Evaluation of streaks was conducted by visually inspecting the TN-mode liquid crystal cell where the optical compensation sheet was interposed between the polarizing plates. The evaluation was conducted according to the following standards.

A: excellent, B: good, C: fair, D: poor

<Evaluation of Unevenness and Hue at a Viewing Angle from Above on the Panel of Liquid Crystal Display Device>

The display panel of each of liquid crystal display devices was adjusted to a medium tone over the entire surface and unevenness of the panel was evaluated. The evaluation was conducted according to the following standards.

A: excellent, B: good, C: fair, D: poor

### <Evaluation of Orientation Property>

As with the evaluation of streaks, orientation property was evaluated by visually inspecting the TN-mode liquid crystal cell. The evaluation was conducted according to the following standards.

A: excellent, B: good, C: fair, D: poor

First, coating conditions such as coating amount, drying rate, and surface tension are shown in Table 1, and the evaluation results of the surface state and optical property of the optical compensation sheets are shown in Table 2.

### Examples 1-2 to 1-6

The same procedures as Example 1-1 were conducted except that the coating conditions were changed as shown in Table 1. The results are shown in Table 2.

### Comparative Examples 1-1 and 1-2

The same evaluations as Example 1-1 were conducted except that the coating conditions were changed as shown in Table 1. The results are shown in Table 2.

TABLE 1

| | Coating | Coating | | | Surface | |
|---|---|---|---|---|---|---|
| | density | amount | Coating rate | Drying rate | tension | Fluoroaliphatic-group- |
| | (kg/L) | [mL/m²] | [m/min] | [g/(m² · sec)] | [mN/m²] | containing polymer |
| Example 1-1 | 0.897 | 5.3 | 32 | 0.44 | 22.6 | ωF(C4 + C6) type |
| Example 1-2 | 0.897 | 5.3 | 60 | 0.82 | 22.6 | polymer P-3 |
| Example 1-3 | 0.882 | 6.4 | 32 | 0.56 | 23.2 | |
| Example 1-4 | 0.882 | 6.4 | 60 | 1.06 | 23.2 | |
| Example 1-5 | 0.882 | 10.6 | 100 | 1.76 | 23.2 | |
| Example 1-6 | 0.882 | 12.0 | 113 | 1.99 | 23.2 | |
| Comparative | 0.897 | 5.3 | 60 | 0.82 | 24.7 | ω-H type polymer P-1 |
| Example 1-1 | | | | | | |
| Comparative | 0.882 | 6.4 | 60 | 1.06 | 24.7 | |
| Example 1-2 | | | | | | |

TABLE 2

| | Surface states | | |
|---|---|---|---|
| | Drying | | |
| | unevenness | Streak | Optical property |
| Example 1-1 | A | B | B |
| Example 1-2 | A | C | B |
| Example 1-3 | B | B | B |
| Example 1-4 | B | C | B |
| Example 1-5 | C | C | C |
| Example 1-6 | C | C | C |
| Comparative | D | D | A |
| Example 1-1 | | | |
| Comparative | D | D | A |
| Example 1-2 | | | |

As shown in Tables 1 and 2, it has been established that use of fluoroaliphatic-group-containing polymers according to the present invention prevents drying unevenness and streaks in optical compensation sheets and provides excellent optical property even in faster coating and faster drying than conventional coating and drying.

In contrast, in Comparative Examples 1-1 and 1-2 where fluoroaliphatic-group-containing polymers according to the present invention were not used, drying unevenness and streaks were caused and optical property was deteriorated in the fast coating and fast drying.

### Examples 1-7 to 1-13

Next, influence to the surface states and the optical property of optical compensation sheets was evaluated when the coating amount and the drying rate were constant at 6.4 mL/m² and 1.06 g/(m²·sec) respectively and the amount of the fluoroaliphatic-group-containing polymer to be added was changed. The results are shown in Table 3.

### Comparative Examples 1-3 to 1-5

The same evaluations as Example 7 were conducted except that the types and the added amounts of the fluoroaliphatic-group-containing polymers were changed as shown in Table 3. The results are shown in Table 3.

TABLE 3

| | Fluoroaliphatic- | Surface | | Surface states | | | |
|---|---|---|---|---|---|---|---|
| | group-containing | tension | Added amount | Drying | | | Optical |
| | polymer | (mN/m²) | (percent by mass) | unevenness | Streak | Orientation | property |
| Example 1-7 | ωF(C4 + C6) type | 22.6 | 0.05 | C | C | A | A |
| Example 1-8 | polymer P-3 | 22.6 | 0.22 | A | A | A | A |
| Example 1-9 | | 22.6 | 0.27 | A | A | A | A |
| Example 1-10 | | 22.6 | 0.29 | A | A | A | B |
| Example 1-11 | | 22.4 | 0.47 | A | A | A | B |
| Example 1-12 | | 22.2 | 0.80 | A | A | B | C |
| Example 1-13 | | 22.1 | 1.00 | A | A | C | C |
| Comparative | —(CF₂CF₂)₂H | 24.7 | 0.47 | D | D | A | A |
| Example 1-3 | | | | | | | |
| Comparative | ω-H type polymer | 24.7 | 0.47 | D | D | A | A |
| Example 1-4 | P-1 | | | | | | |
| Comparative | None | 24.7 | 0 | D | D | A | A |
| Example 1-5 | | | | | | | |

As shown in Table 3, use of the fluoroaliphatic-group-containing copolymers having end structures of —(CF₂CF₂)₂F and —(CF₂CF₂)₃F provided excellent evaluation results in drying unevenness, streaks, orientation property, and optical property as a whole. When the added amount of the fluoroaliphatic-group-containing copolymers was from 0.05 to 1 percent by mass, excellent evaluation results were obtained in drying unevenness, streaks, orientation property, and optical property as a whole (Examples 1-7 to 1-13).

In contrast, when the fluoroaliphatic-group-containing polymers having the end structure of —(CF₂CF₂)ₙH (n=2 or 3) were used, optical compensation sheets had excellent orientation property, but drying unevenness and streaks heavily occurred and surface states were thus deteriorated (Comparative Examples 1-3 and 1-4). Similar results were also obtained when no fluoroaliphatic-group-containing polymer was added (Comparative Example 1-5).

### Example 2

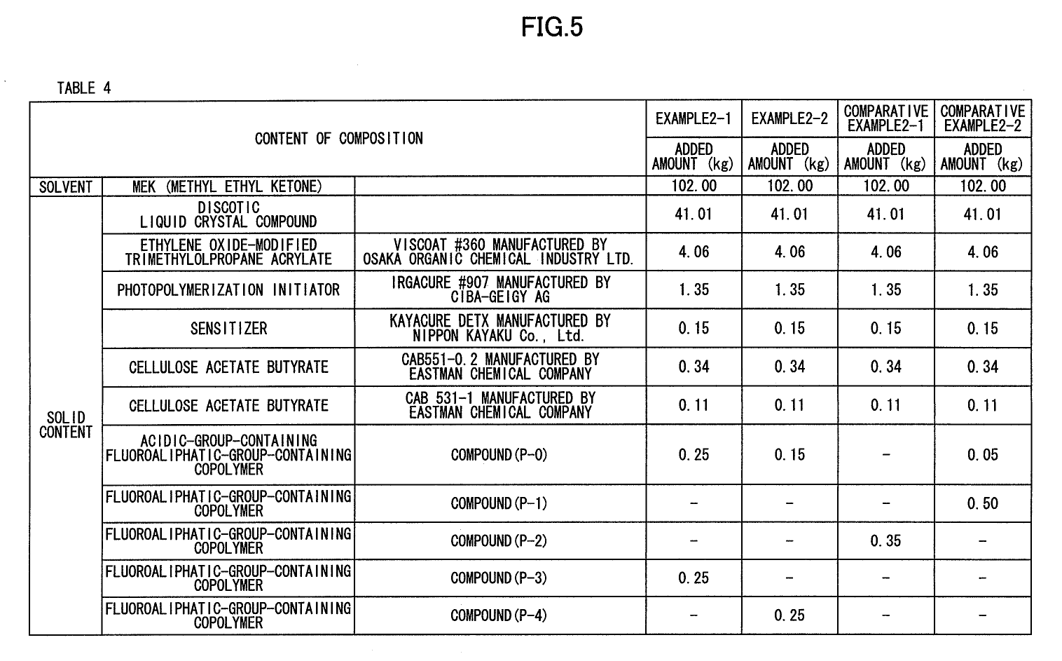

Coating solutions were prepared based on the composition of the coating solution for an optically anisotropic layer in Example 1 except that the composition ratios of the fluoroaliphatic-group-containing polymer and the acidic-group-containing fluoroaliphatic-group-containing polymer were changed as shown in Table 4 in FIG. 5. The coating solutions having various compositions of the fluoroaliphatic-group-containing polymer and the like were coated on transparent substrates by extrusion coating method (E type). The relationship was evaluated between variations of the surface tensions of the coating solutions over time from immediately after the solutions were coated and appearance property.

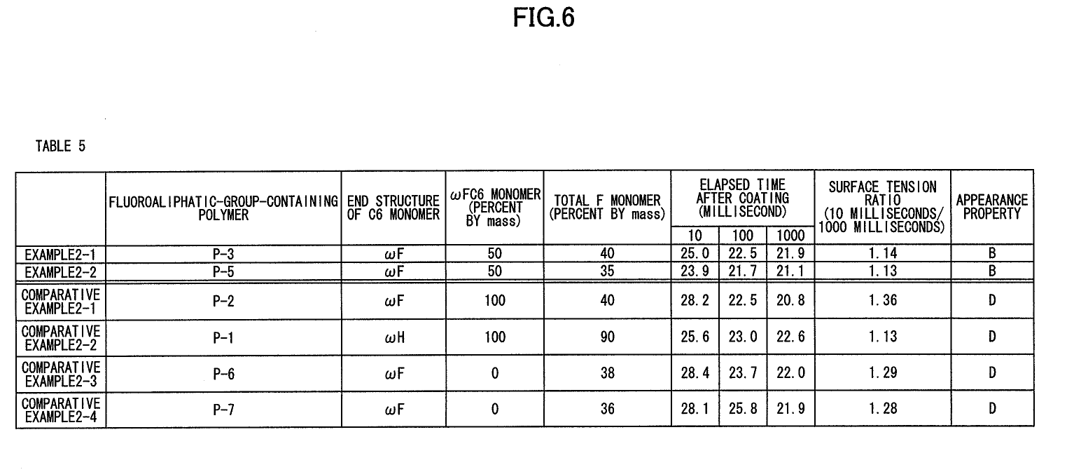

The surface tensions of the coating solutions were measured by maximum bubble pressure method by using a dynamic surface tension measurement apparatus (MPT2, manufactured by LAUDA). In the method, a certain amount of the coating solution containing the fluoroaliphatic-group-containing polymer was charged in a beaker, nitrogen gas was blown from a capillary inserted into the solution to inflate bubble, and surface tension was obtained from the maximum pressure on expanding the interface between the liquid and the gas. The results are shown in Table 5 in FIG. 6.

As shown in Table 5, Examples 2-1 and 2-2 using ω(C4+C6) type polymers as the fluoroaliphatic-group-containing polymer showed lower surface tensions immediately after coating than Comparative Examples 2-1, 2-3, and 2-4 using the ωFC4 type polymer or ωFC6 type polymer alone. Examples 2-1 and 2-2 showed a small surface tension ratio (surface tension after 10 milliseconds/surface tension after 1000 milliseconds) of 1.1 as shown in FIG. 5.

Based on such results, it has been established that the adsorption rate to the air interface immediately after coating is faster and the effect of stabilizing the surface of the coated film is higher in Examples 2-1 and 2-2 using the ωF(C4+C6) type polymers as the fluoroaliphatic-group-containing polymer than in Comparative Examples 2-1, 2-3, and 2-4 using the ωFC4 type polymer or ωFC6 type polymer alone. It has been thus established that use of the present invention can prevent unevenness defects caused by initial drying to enhance the appearance property of optical films.

In Comparative Example 2-2 where the ωH type polymer was used as the fluoroaliphatic-group-containing polymer, it has been found that the obtained film has low surface tension and fast adsorption rate to the air interface immediately after coating whereas the film does not provide the effect of stabilizing the air interface sufficiently because the ωH type polymer partly has H groups, and the film shows deteriorated appearance property. Similar tests were conducted by bar coating method, and the similar results were obtained.

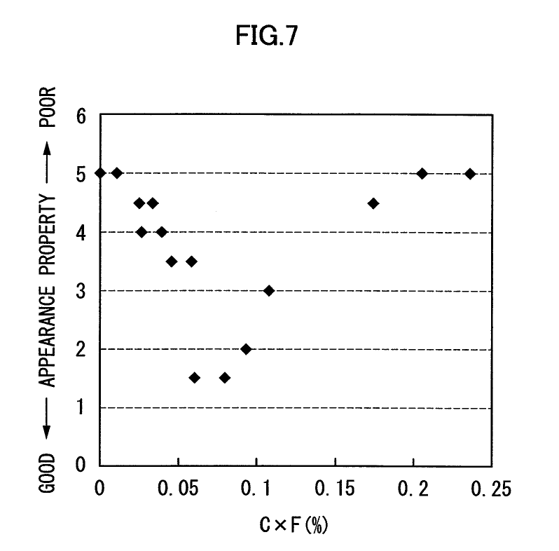

Next, the appearance property of an optically anisotropic layer was summarized in relation to the total content of fluorine in a coating solution for forming the optically anisotropic layer (a product of C and F where C represents concentration (percent by mass) of a fluoroaliphatic-group-containing polymer and F represents fluorine content (percent) in the fluoroaliphatic-group-containing polymer. The fluoroaliphatic-group-containing polymer was a ωF(C4+C6) type polymer in which ωFC6 monomer:ωFC4 monomer=50:50. The appearance property was evaluated in 5 grades where 3 was a standard point. The smaller from the standard point 3 the grade is, the particularly better the appearance property is. The larger from the standard point 3 the grade is, the worse the appearance property is. The results are shown in FIG. 7.

As shown in FIG. 7, when the product of C and F was less than 0.05, there was a tendency that the liquid crystal compound is not sufficiently controlled at the air interface, and unevenness occurred in the orientation property of the liquid crystal compound. When the product of C and F was greater than 0.12, there was a tendency that cissing defects were caused in coating the coating solution for forming the optically anisotropic layer. Consequently, it has been established that unevenness caused in the initial drying can be further reduced and good appearance property can be obtained when the total content of fluorine in a composition for forming an optically anisotropic layer (the product of C and F) is 0.05 to 0.12 percent by mass.

In summary, it has been established that drying unevenness can be certainly prevented and good appearance property can be obtained in the following conditions: 1) a coating solution contains a fluoroaliphatic-group-containing copolymer including a ωF(C4+C6) type polymer, and 2) the coating solution has a surface tension ratio between surface tensions after 10 milliseconds and after 1000 milliseconds (surface tension after 10 milliseconds/surface tension after 1000 milliseconds) of 1.0 to 1.2 determined by maximum bubble pressure method when a product of C and F is 0.05 to 0.12 where C represents concentration (percent by mass) of the fluoroaliphatic-group-containing polymer in the coating solution and F represents fluorine content (percent) in the fluoroaliphatic-group-containing polymer.

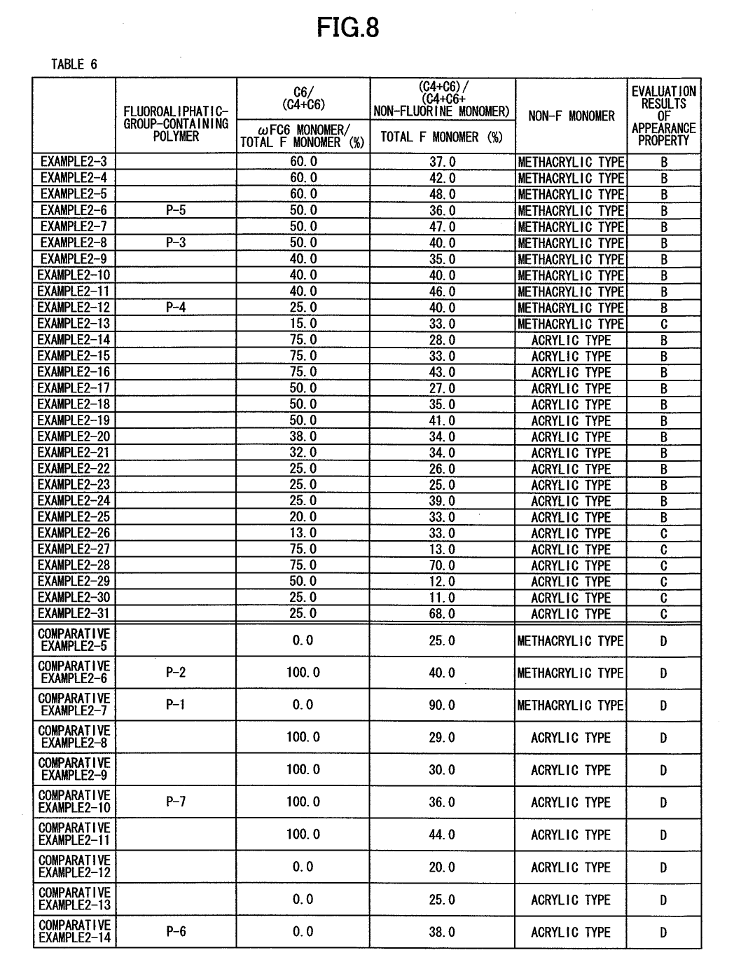

Next, the appearance properties of optically anisotropic layers were evaluated which layers were formed by the coating solutions in FIG. 4 where the compositions of the fluoroaliphatic-group-containing polymers were changed (Examples 2-3 to 2-31, and Comparative Examples 2-5 to 2-14). Note that the compositions of the coating solutions were almost the same as those of the coating solutions for forming optically anisotropic layers except that the types of the fluoroaliphatic-group-containing polymers were changed. The results are shown in Table 6 in FIG. 8.

As shown in Table 6, it has been established that good appearance property can be obtained when the ωFC6 monomer contained in the fluoroaliphatic-group-containing polymer has a ratio (=ωFC6 monomer/(ωFC4 monomer+ωFC6 monomer)) of from 20 to 80 percent by mass and the total fluorine content in the fluoroaliphatic-group-containing polymer is from 20 to 50 percent by mass. In particular, appearance property was good in Examples 2-3 to 2-13 where non-fluorine monomer structures constituting the fluoroaliphatic-group-containing polymers were methacrylic types.

### Example 3

Next, unevenness and inclination angle of a liquid crystal cell were evaluated when an inclination angle auxiliary was added besides a fluoroaliphatic-group-containing polymer to a composition for forming an optically anisotropic layer.

### Example 3-1

### <Preparation of Polymer Substrate>

The following compositions were charged in a mixing tank and stirred while heating at 30° C., thereby dissolving the respective components to prepare a cellulose acetate solution.

| Composition of cellulose acetate solution | Internal | External |
|---|---|---|
| (parts by mass) | layer | layer |
| Cellulose acetate having a degree of acetylation of | 100 | 100 |
| 60.9% | | |
| Triphenyl phosphate (plasticizer) | 7.8 | 7.8 |
| Biphenyl diphenyl phosphate (plasticizer) | 3.9 | 3.9 |
| Methylene chloride (first solvent) | 293 | 314 |
| Methanol (second solvent) | 71 | 76 |
| 1-Butanol (third solvent) | 1.5 | 1.6 |
| Silica fine particle (AEROSIL R972, manufactured by | 0 | 0.8 |
| Nippon Aerosil Co., Ltd) | | |
| Retardation increasing agent as described below | 1.7 | 0 |

| | |
|---|---|
| | [Formula 42] |
| 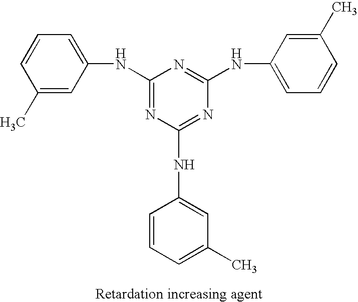 | |

The resulting dope for the internal layer and dope for the external layer were cast on a drum cooled at 0° C. using a three-layer co-casting die. A film having an amount of the residual solvent of 70 percent by mass was stripped off from the drum and dried at 80° C. while the both ends of the film were fixed by using a pin tenter and the film was delivered in a drawing ratio of 115% in the delivery direction. When the amount of the residual solvent reached 10%, the film was dried at 110° C. After that, the resulting film was dried at a temperature of 155° C. for 20 minutes to prepare a cellulose acetate film having an amount of the residual solvent of 0.3 percent by mass (external layer: 3 μm, internal layer: 74 μm, external layer: 3 μm). Thus prepared cellulose acetate film was processed into a polymer substrate (PK-2), and the optical property of the PK-2 was measured.

The polymer substrate (PK-2) had a width of 1,340 mm and a thickness of 75 μm. A retardation value (Re) at a wavelength of 630 nm was measured by using an ellipsometer (M-150 manufactured by JASCO Corporation). The lag phase axis was orthogonal to the delivery direction, and the retardation value was 16 nm. Also, a retardation value (Rth) at a wavelength of 630 nm was measured, and the value was 90 nm.

The polymer substrate (PK-2) was immersed in a 2.0 N potassium hydroxide solution (at 25° C.) for 2 minutes, subsequently neutralized with sulfuric acid, washed with pure water, and dried. Surface energy of the polymer substrate (PK-2) was determined by a contact angle method, and the energy was 63 mN/m.

An orientation-film coating solution having the following composition was coated in an amount of 28 mL/m² on a surface of the polymer substrate (PK-2) by using a #16 wire bar coater. The coated solution was dried by using warm air at 60° C. for 60 seconds and further by using warm air at 90° C. for 150 seconds.

### (Composition of Orientation-Film Coating Solution)

Modified polyvinyl alcohol described below: 10 parts by mass
Compound X described below: 0.01 parts by mass
Water: 371 parts by mass
Methanol: 119 parts by mass
Glutaraldehyde (crosslinking agent): 0.5 parts by mass

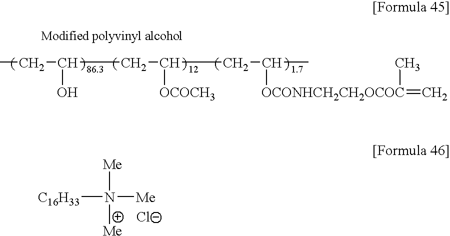

The orientation film was subjected to rubbing treatment in the direction of the normal to the lag phase axis (measured at a wavelength of 632.8 nm) of the polymer substrate (PK-2).

### <Formation of Optically Anisotropic Layer>

### (Composition of Coating Solution for Optically Anisotropic Layer)

Discotic liquid crystal compound described below: 41.01 parts by mass

Ethylene oxide-modified trimethylolpropane triacrylate (V#360, manufactured by Osaka Organic Chemical Industry Ltd.): 4.06 parts by mass

Cellulose acetate butyrate (CAB551-0.2 manufactured by Eastman Chemical Company): 0.34 parts by mass

Cellulose acetate butyrate (CAB531-1 manufactured by Eastman Chemical Company): 0.11 parts by mass

Compound P described below: 0.27 parts by mass

Compound O described below: 0.20 parts by mass

Photopolymerization initiator (IRGACURE 907 manufactured by Ciba-Geigy AG): 1.35 parts by mass

Sensitizer (KAYACURE DETX, manufactured by Nippon Kayaku Co., Ltd.: 0.45 parts by mass

ωF(C4+C6) type polymer P-3 in the 1): 0.27 parts by mass

The composition A for an optically anisotropic layer was dissolved in methyl ethyl ketone to prepare a coating solution 14 having a specific gravity of 0.900.

### Acidic-Group-Containing Fluoroaliphatic-Group-Containing Polymer

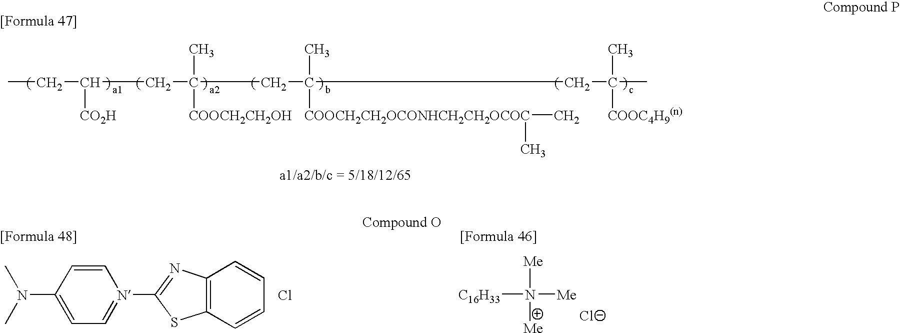

An upstream lip land length (IUP) was set to be 1 mm, and a downstream lip land length (ILO) was set to be 50 μm. By using a slot die 16, the coating solution was coated on the web 12 in 5.2 ml/m². The coating rate was 60 m/min. As for the web 12, there was used the polymer substrate (PK-2) to which an orientation film was coated. The gap length between the web 12 and the downstream lip land was set to be 40 μm. The orientation film was subjected to rubbing treatment in the direction of the normal to the lag phase axis (measured at a wavelength of 632.8 nm) of the polymer substrate (PK-2). Then the coating solution was continuously coated on the orientation film subjected to the rubbing treatment, and the solution was heated at 125° C. for 2 minutes to orient the discotic liquid crystal compound. Note that conditions of the rubbing treatment such as the rotational peripheral velocity of a rubbing roller and pressure of the rubbing roller against the resin layer of the orientation film were the same as Example A.

Next, the coated layer was irradiated with ultraviolet rays at 100° C. for 1 minute by using a 120 W/cm high-pressure mercury-vapor lamp to polymerize the discotic liquid crystal compound. After that, the coated layer was allowed to cool to room temperature. Thus an optical compensation sheet (KH-2) with an optically anisotropic layer was prepared.

The optically anisotropic layer had an Re retardation value of 50 nm measured at a wavelength of 546 nm. The optically anisotropic layer was positioned so that the layer was substantially orthogonal to the parallel direction to the line obtained by objecting the director direction of liquid crystal molecules onto the surface of the transparent substrate.

The polarizing plate was positioned in cross-Nicol configuration, and the resulting optical compensation sheet was observed with respect to the presence of unevenness. As a result, no unevenness was observed even by viewing the sheet in the front direction and in the oblique direction inclined by 60° from the normal direction.

### <Preparation of Polarizer>

PVA having an average degree of polymerization of 4,000 and a saponification degree of 99.8 mol % was dissolved in water to obtain a 4.0% aqueous solution. The solution was band cast by using a tapered die and dried to form a film having a width of 110 mm and a thickness of 120 μm on the left end and 135 μm on the right end before being stretched.

The film was stripped off from the band, and obliquely stretched to the direction at 45° in dried state, immersed in an aqueous solution of 0.5 g/L of iodine and 50 g/L of potassium iodide at 30° C. for 1 minute, subsequently immersed in an aqueous solution of 100 g/L of boric acid and 60 g/L of potassium iodide at 70° C. for 5 minutes, rinsed with water in a rinsing bath at 20° C. for 10 seconds, and dried at 80° C. for 5 minutes to obtain an iodine-based polarizer (HF-1). The polarizer had a width of 660 mm and a thickness of 20 μm both on the left and right ends.

### <Preparation of Polarizing Plate>

Onto one surface of the polarizer (HF-1), the optical compensation sheet (KH-2) was attached on the polymer substrate (PK-2) side by using a polyvinyl alcohol-based adhesive. An 80 μm-thick triacetyl cellulose film (TD-80U, produced by Fuji Photo Film Co., Ltd.) was saponified and attached to the opposite side of the polarizer by using a polyvinyl alcohol-based adhesive.

The transmission axis of the polarizer and the lag phase axis of the polymer substrate (PK-2) were positioned to be parallel to each other. The transmission axis of the polarizer and the lag phase axis of the triacetyl cellulose film were positioned to intersect at right angles. A polarizing plate (HB-2) was thus prepared.

### Examples 3-2 to 3-4

Optical compensation sheets were prepared as with Example 3-1 except that the added amount of the compounds P and O used in Example 3-1 and properties were changed as shown in Table 7.

### <Evaluation of TN Liquid Crystal Cell>

A pair of polarizing plates provided in a liquid crystal display device (LL-191A, manufactured by Sharp Corporation) using a TN-mode liquid crystal cell was stripped off and instead, one sheet of the polarizing plate (HB-2) prepared in Example 1 was attached to each of the observer side and the backlight side of the device via an adhesive such that the optical compensation sheet (KH-2) was on the liquid crystal cell side. The polarizing plates were positioned so that the transmission axis of the polarizing plate on the observer side and the transmission axis of the polarizing plate on the backlight side formed an O-mode.

Also, the viewing angle of the prepared liquid crystal display device was measured in 8 steps of from black display (L1) to white display (L8) by using a measuring machine (EZ-Contrast 160D, manufactured by ELDIM). In the same manner, liquid crystal display devices were prepared and viewing angle contrasts were measured in Examples 3-2 to 3-4. The results of viewing angles in which contrast ratios were 15 or more are shown in Table 7. Grayscale inversion on the black side was judged by reversal between L1/3 and L2/3. The results of grayscale inversion angle downward are shown in Table 8.

### <Evaluation of Unevenness on Liquid Crystal Display Device Panel>

The display panel of each of liquid crystal display devices in Examples 3-1 to 3-4 was adjusted to a medium tone over the entire surface and unevenness of the panel was evaluated. The results are shown in Table 8.

### <Evaluation of Inclination Angle of Liquid Crystal Compound>

The inclination angles in the vicinity of the orientation film and the inclination angles in the vicinity of the air interface of a liquid crystal compound in the optically anisotropic layer of an optical compensation sheet were determined by measuring the retardations from various observation angles by using an ellipsometer (APE-100 manufactured by SHIMADZU CORPORATION), and assuming a refractive index ellipsoid model from the measured retardations, and calculating the angles according to a procedure described in Designing Concepts of the Discotic Negative Birefringence Compensation Films, SID98 DIGEST. The measurement wavelength was 632.8 nm. The results are shown in Table 7.

TABLE 7

| | | | | Liquid crystal layer | | |
|---|---|---|---|---|---|---|
| | Transparent film (TAC) | | | | Inclination angle (°) | Inclination angle (°) |
| | Direction of lag | Re | Rth | | on the air interface | on the orientation |
| | phase axis* | (nm) | (nm) | Thickness | side | film side |
| Example 3-1 | Orthogonal | 16 | 90 | 1.73 | 60 | 30 |
| Example 3-2 | Parallel | 6 | 90 | 1.73 | 60 | 30 |
| Example 3-3 | Orthogonal | 16 | 90 | 1.73 | 78 | 12 |
| Example 3-4 | Parallel | 6 | 90 | 1.73 | 78 | 12 |

TABLE 8

| | Viewing angle | | | |
|---|---|---|---|---|
| | (CR > 15) | | | |
| | Side to | Up and | Downward grayscale | |
| | side | down | inversion angle (°) | Unevenness |
| Example 3-1 | 170 | 170 | 32 | B |
| Example 3-2 | 170 | 160 | 30 | B |
| Example 3-3 | 170 | 160 | 27 | B |
| Example 3-4 | 170 | 152 | 27 | B |

As shown in Tables 7 and 8, in optical compensation sheets according to the present invention, which sheets have an inclination angle on the orientation film side of 20° or more and an inclination angle on the air interface side of 70° or less, the downward grayscale inversion angles of liquid crystal display devices were sufficiently increased and the sheets considerably contribute to increase of viewing angles, and no unevenness was generated (Examples 3-1 and 3-2). In contrast, in optical compensation sheets which do not have an inclination angle on the orientation film side of 20° or more and an inclination angle on the air interface side of 70° or less (Examples 3-3 and 3-4), the downward grayscale inversion angles and viewing angles were not sufficiently increased.

### Example 3-5

Optical compensation sheets and polarizing plates with optical compensation sheets were prepared as with Example 3-1 except that the added amount of the retardation increasing agent used in Example 3-1 was changed to prepare polymer substrates having Rth of 70, 80, 100, and 110 nm, respectively. Even when the Rth of the polymer substrates were changed to 70, 80, 100, and 110 nm, effects similar to those obtained in Example 3-1 were obtained in the viewing angles of up and down and side to side.

### Example 3-6

An optical compensation sheet and a polarizing plate with an optical compensation sheet were prepared as with Example 3-1 except that the retardation increasing agent used in Example 3-1 was replaced by the following retardation increasing agent, the added amount to the internal layer was changed to 1.4 parts by mass, and a polymer substrate having Rth of 95 nm was prepared. Effects similar to those obtained in Example 3-1 were obtained.

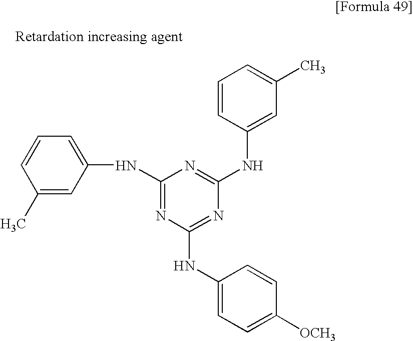

### Example 3-7

Optical compensation sheets and polarizing plates with optical compensation sheets were prepared as with Example 3-1 except that the added amount of the retardation increasing agent used in Example 3-6 was changed to prepare polymer substrates having Rth of 70, 80, 90, 100, 110 and 120 nm, respectively. Even when the Rth of the polymer substrates were changed to 70, 80, 90, 100, 110 and 120 nm, effects similar to those obtained in Example 3-1 were obtained.

What is claimed is:

1. A method for producing an optical film comprising steps of:
coating a coating solution containing a liquid crystal compound on a flexible strip substrate being transferred in a coating amount of 4.5 to 12 mL/m², and
subsequently drying and curing the coating solution to form an optically anisotropic layer,
wherein the coating solution contains a fluoroaliphatic-group-containing polymer including repeating units derived from monomers in the following (i), and the coating solution also satisfies the following condition (ii), where
(i) the fluoroaliphatic-group-containing polymer is a fluoroaliphatic-group-containing copolymer including a first fluoroaliphatic-group-containing monomer having an end structure represented by —(CF₂CF₂)₃F, and a second fluoroaliphatic-group-containing monomer having an end structure represented by —(CF₂CF₂)₂F; and
(ii) the coating solution has a surface tension ratio between surface tensions after 10 milliseconds and after 1000 milliseconds (surface tension after 10 milliseconds/surface tension after 1000 milliseconds) of 1.0 to 1.2 determined by maximum bubble pressure method when a product of C and F is 0.05 to 0.12 where C represents concentration (percent by mass) of the fluoroaliphatic-group-containing polymer in the coating solution and F represents fluorine content (percent) in the fluoroaliphatic-group-containing polymer.

2. The method for producing an optical film according to claim 1, wherein the optically anisotropic layer contains 0.05 to 1 percent by mass of the fluoroaliphatic-group-containing polymer.

3. The method for producing an optical film according to claim 1, wherein the fluoroaliphatic-group-containing polymer contains 20 to 80 percent by mass of the first fluoroaliphatic-group-containing monomer based on the total amount of the first and the second fluoroaliphatic-group-containing monomers.

4. The method for producing an optical film according to claim 1, wherein the total amount of the first and the second fluoroaliphatic-group-containing monomers is 20 to 50 percent by mass based on the total amount of the fluoroaliphatic-group-containing polymer.

5. The method for producing an optical film according to claim 1, wherein
the first and the second fluoroaliphatic-group-containing monomers are represented by the following monomer (i), and
the fluoroaliphatic-group-containing polymer is a fluoroaliphatic-group-containing copolymer including a repeating unit derived from the following monomer (i) and a repeating unit derived from the following monomer (ii),
(i) a fluoroaliphatic-group-containing monomer represented by the following general formula [1]
(ii) poly(oxyalkylene)acrylate and/or poly(oxyalkylene)methacrylate general formula [1] 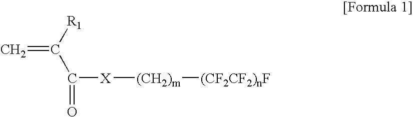
wherein R₁ represents a hydrogen atom or a methyl group; X represents an oxygen atom, a sulfur atom, or —N(R₂)—; m represents an integer of 1 to 6 inclusive; and n represents an integer of 2 or 3; and R₂ represents a hydrogen atom or an alkyl group having 1 to 4 carbon atoms.

6. The method for producing an optical film according to claim 5, wherein the fluoroaliphatic-group-containing polymer is a fluoroaliphatic-group-containing copolymer including a repeating unit derived from the following monomer (i), a repeating unit derived from the following monomer (ii), and a repeating unit derived from the following monomer (iii),
(i) a fluoroaliphatic-group-containing monomer represented by the general formula [1] in claim 5,
(ii) poly(oxyalkylene)acrylate and/or poly(oxyalkylene)methacrylate,
(iii) a monomer represented by the following general formula [2] that is copolymerizable with the (i) and (ii),
general formula [2] 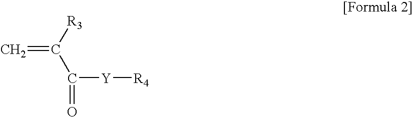
wherein R₃ represents a hydrogen atom or a methyl group; Y represents a divalent coupling group; and R₄ represents a linear, branched, or cyclic alkyl group that comprises 4 to 20 carbon atoms inclusive and may optionally comprise a substituent.

7. The method for producing an optical film according to claim 1, wherein drying rate of the coating solution is 0.4 to 1.1 [g/(m²·sec)].

8. The method for producing an optical film according to claim 1, wherein the coating solution is coated by using a slot die.

9. The method for producing an optical film according to claim 1, wherein the liquid crystal compound is a discotic liquid crystal compound.

10. An optical film produced by the method for producing an optical film according to claim 1.
